(19) United States
(12) Patent Application Publication
(10) Pub. No.: US 2025/0231520 A1
(43) Pub. Date: Jul. 17, 2025

(54) ELECTROPHOTOGRAPHIC APPARATUS AND PROCESS CARTRIDGE

(71) Applicant: CANON KABUSHIKI KAISHA, Tokyo (JP)

(72) Inventors: HARUHIKO MITSUDA, Chiba (JP); KENICHI IKARI, Chiba (JP); KENTARO KAMAE, Kanagawa (JP); NAOAKI ICHIHASHI, Chiba (JP)

(21) Appl. No.: 18/981,891

(22) Filed: Dec. 16, 2024

(30) Foreign Application Priority Data
Jan. 11, 2024 (JP) 2024-002680
Oct. 8, 2024 (JP) 2024-176749

(51) Int. Cl. G03G 21/18; G03G 7/00; G03G 9/087

(52) U.S. Cl. CPC G03G 21/1814; G03G 7/0013; G03G 9/08755; G03G 2221/1606

(57) ABSTRACT

An electrophotographic apparatus including: an electrophotographic photosensitive member; a developing unit, which includes a toner, and which is configured to develop an electrostatic latent image with the toner to form a toner image on a surface of the electrophotographic photosensitive member; and a cleaning unit configured to remove a residual toner remaining on the surface of the electrophotographic photosensitive member after the toner image is transferred from the surface of the electrophotographic photosensitive member onto a transfer material, wherein the surface of the electrophotographic photosensitive member is formed of amorphous silicon carbide, wherein a Si atom density in a region in the vicinity of the surface of the electrophotographic photosensitive member from the surface to a depth of 100 nm is 1.0×10²² atoms/cm³ or less, and wherein the toner contains a toner particle that contains a polyester resin having a polyethylene terephthalate segment and an inorganic fine particle.

### BACKGROUND OF THE INVENTION

### Field of the Invention

The present invention relates to an electrophotographic apparatus using an electrophotographic photosensitive member having a surface formed of amorphous silicon carbide, and a process cartridge.

### Description of the Related Art

An electrophotographic image forming method (hereinafter sometimes simply referred to as “image forming method”) and an electrophotographic apparatus using the electrophotographic image forming method have been generally widely used in a copying machine, a facsimile, and a printer. In such electrophotographic apparatus, the surface of an electrophotographic photosensitive member having a photoconductive layer formed thereon is uniformly charged and exposed to light with a laser or an LED in accordance with image information to form an electrostatic latent image on the surface of the electrophotographic photosensitive member. Then, a toner is caused to adhere to the formed electrostatic latent image to form a toner image on the surface of the electrophotographic photosensitive member, and the toner image is transferred onto a transfer material such as paper to perform image formation. As an electrophotographic photosensitive member that may be suitably used in such electrophotographic apparatus, an amorphous silicon electrophotographic photosensitive member that uses hydrogenated amorphous silicon in a photoconductive layer is known. The hydrogenated amorphous silicon is also abbreviated as “a-Si:H”, the electrophotographic photosensitive member is also abbreviated as “photosensitive member,” and the amorphous silicon electrophotographic photosensitive member is also abbreviated as “a-Si photosensitive member.” The a-Si photosensitive member is significantly hard, having a Vickers hardness of 1,000 kgf/mm² or more, and is excellent in durability, heat resistance, and environmental stability. Thus, the a-Si photosensitive member is preferably used in a high-speed machine that particularly requires high reliability.

Meanwhile, the a-Si photosensitive member has a small wear amount and a high surface frictional resistance, and hence abnormalities may occur in an output image due to the defect in a cleaning step of the photosensitive member with a cleaning blade. In order to relieve this problem, there has been known a technology for suppressing the occurrence of an image defect by controlling the surface roughness of the a-Si photosensitive member (Japanese Patent No. 6,619,433).

In addition, in recent years, in order to reduce the energy usage amount of the electrophotographic apparatus, there has been proposed a technology for fixing a toner at low temperature. In Japanese Patent Application Laid-Open No. 2004-280085, there is described a technology regarding a toner containing, as one of resin components, polyester obtained by causing a polyethylene terephthalate resin, an alcohol component, and a carboxylic acid component to react with each other.

### SUMMARY OF THE INVENTION

The inventors have made investigations, and as a result, have found that, when the a-Si photosensitive member and the toner containing a polyester resin having a polyethylene terephthalate segment described in the literatures of the related art are used in combination, there is the following problem. When the usage environment has high temperature and high humidity, a streak-like image defect that seems to be derived from the passing of the toner through a cleaned portion of the photosensitive member has occurred in an initial stage of use in some cases.

Thus, an object of the present disclosure is to provide an electrophotographic apparatus in which the occurrence of a streak-like image defect is suppressed even under a high-temperature and high-humidity usage environment when an a-Si photosensitive member and a toner containing a polyester resin having a polyethylene terephthalate segment are used in combination.

The object is achieved by the present disclosure described below.

That is, there is provided an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image with the toner to form a toner image on the surface of the electrophotographic photosensitive member; a transfer unit configured to transfer the toner image from the surface of the electrophotographic photosensitive member onto a transfer material; and a cleaning unit configured to remove a residual toner remaining on the surface of the electrophotographic photosensitive member after the toner image is transferred onto the transfer material, wherein the surface of the electrophotographic photosensitive member is formed of amorphous silicon carbide, wherein a Si atom density in a region in the vicinity of the surface of the electrophotographic photosensitive member from the surface to a depth of 100 nm is 1.0×10²² atoms/cm³ or less, and wherein the toner contains a toner particle that contains a polyester resin having a polyethylene terephthalate segment and an inorganic fine particle.

In addition, there is provided a process cartridge including: an electrophotographic photosensitive member; a developing unit, which includes a toner, and which is configured to develop an electrostatic latent image formed on a surface of the electrophotographic photosensitive member with the toner to form a toner image on the surface of the electrophotographic photosensitive member; and a cleaning unit configured to remove a residual toner remaining on the surface of the electrophotographic photosensitive member after the toner image is transferred from the surface of the electrophotographic photosensitive member onto a transfer material, the process cartridge integrally supporting the electrophotographic photosensitive member, the developing unit, and the cleaning unit, and being detachably attachable onto a main body of an electrophotographic apparatus, wherein the surface of the electrophotographic photosensitive member is formed of amorphous silicon carbide, wherein a Si atom density in a region in the vicinity of the surface of the electrophotographic photosensitive member from the surface to a depth of 100 nm is 1.0×10²² atoms/cm³ or less, and wherein the toner contains a toner particle that contains a polyester resin having a polyethylene terephthalate segment and an inorganic fine particle.

Further features of the present invention will become apparent from the following description of exemplary embodiments with reference to the attached drawings.

### BRIEF DESCRIPTION OF THE DRAWINGS

FIG. 1 is a schematic view for illustrating an example of an image forming method using an electrophotographic apparatus that uses a photosensitive member in the present disclosure.

FIG. 2 is a schematic view for illustrating an example of a layer configuration of the photosensitive member in the present disclosure.

FIG. 3 is a view for schematically illustrating an example of a deposition apparatus using an RF plasma CVD method that uses a high-frequency power supply, which may be used for producing the photosensitive member in the present disclosure.

FIG. 4 is a schematic view for illustrating an example of an electrophotographic apparatus including a process cartridge that includes an electrophotographic photosensitive member in the present disclosure.

### DESCRIPTION OF THE EMBODIMENTS

The embodiment of an electrophotographic apparatus according to the present disclosure is as described below.

That is, the electrophotographic apparatus is an electrophotographic apparatus including: an electrophotographic photosensitive member; a charging unit configured to charge a surface of the electrophotographic photosensitive member; an image exposing unit configured to irradiate the charged surface of the electrophotographic photosensitive member with image exposure light to form an electrostatic latent image on the surface of the electrophotographic photosensitive member; a developing unit, which includes a toner, and which is configured to develop the electrostatic latent image with the toner to form a toner image on the surface of the electrophotographic photosensitive member; a transfer unit configured to transfer the toner image from the surface of the electrophotographic photosensitive member onto a transfer material; and a cleaning unit configured to remove a residual toner remaining on the surface of the electrophotographic photosensitive member after the toner image is transferred onto the transfer material, wherein the surface of the electrophotographic photosensitive member is formed of amorphous silicon carbide, wherein a Si atom density in a region in the vicinity of the surface (hereinafter sometimes referred to as “surface region A”) of the electrophotographic photosensitive member from the surface to a depth of 100 nm is 1.0×10²² atoms/cm³ or less, and wherein the toner contains a toner particle that contains a polyester resin having a polyethylene terephthalate segment and an inorganic fine particle.

The inventors conceive the mechanism via which the electrophotographic apparatus according to the present disclosure solves the problem to be described below.

The inventors presume the cause for the occurrence of a streak-like image defect that occurs when an a-Si photosensitive member and a toner containing a polyester resin having a polyethylene terephthalate segment are used in combination under a high-temperature and high-humidity usage environment to be described below.

The toner containing a polyester resin having a polyethylene terephthalate segment tends to have higher polarity through introduction of the polyethylene terephthalate segment, as compared to a polyester resin that is generally used in a toner. As a result, the affinity for water thereof tends to be increased. In particular, it is conceived that moisture is easily adsorbed to the polyethylene terephthalate segment.

In addition, it is known that a Si atom that is present in the a-Si photosensitive member becomes Si—O when oxidized. It is conceived that moisture is easily adsorbed to this Si—O moiety. When the a-Si photosensitive member and the toner containing a polyester resin having a polyethylene terephthalate segment are used in combination under a high-temperature and high-humidity environment, the polyethylene terephthalate segment of the toner and the Si—O moiety of the photosensitive member specifically interact with each other through water. It is presumed that the foregoing increases the adhesion force between the toner and the photosensitive member to cause the effect that the toner is hardly cleaned, and the toner passes through a cleaning blade, resulting in the occurrence of a streak-like image defect.

In addition, it has been found that the above-mentioned streak-like image defect is liable to occur, in particular, in an initial stage of use of the electrophotographic apparatus.

In the present disclosure, the initial stage of use of the electrophotographic apparatus means a period from the start of the output of an image to the output of the image on about tens of sheets. It is conceived that, during this period, almost no inorganic fine particle supplied from the toner is present in a nip portion of a cleaning blade of the photosensitive member, and the cleaning is in a low stable state. It is conceived that, due to the low stability of cleaning in the initial stage of use of the electrophotographic apparatus, a streak-like image defect may be particularly liable to occur.

The inventors have made extensive investigations, and as a result, have found that, when the Si atom density in a region in the vicinity of the surface (surface region A) of the a-Si photosensitive member from the surface to a depth of 100 nm is controlled to be 1.0×10²² atoms/cm³ or less, the occurrence of an image defect in the initial stage of use can be suppressed even under the high-temperature and high-humidity usage environment.

The inventors presume the above-mentioned mechanism as described below.

That is, it is presumed that, when the Si atom is oxidized to become Si—O in the surface region A of the photosensitive member, the interaction with the above-mentioned polyethylene terephthalate segment of the toner becomes particularly strong, and the stability of cleaning of the toner is significantly influenced. The amount of Si—O in the surface region A of the photosensitive member at the time of image output is reduced by controlling the Si atom density in the surface region A of the photosensitive member to a specified range or less. It is conceived that, as a result, the interaction with the above-mentioned polyethylene terephthalate segment of the toner is reduced to suppress the occurrence of a streak-like image defect. An amorphous silicon photosensitive member having a surface formed of amorphous silicon carbide has a significantly small wear amount. It is presumed that the effect of the present disclosure is unrelated to the wear amount of the surface of the photosensitive member because the surface of the photosensitive member is hardly worn at approximately the number of output sheets in which a streak-like image defect in the initial stage of use of the electrophotographic apparatus occurs/is alleviated.

The embodiments of the present disclosure are described in detail below.

### [Electrophotographic Apparatus]

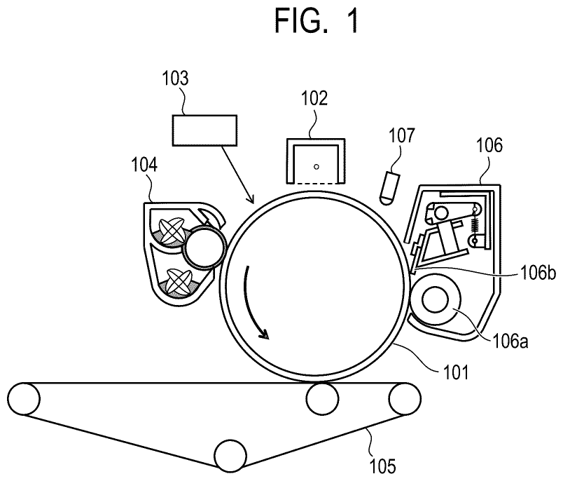

An image forming method using an electrophotographic apparatus that uses the a-Si photosensitive member in the present disclosure is described with reference to FIG. 1.

First, an electrophotographic photosensitive member 101 is rotated, and the surface of the electrophotographic photosensitive member 101 is uniformly charged by a charging unit 102. After that, the surface of the electrophotographic photosensitive member 101 is irradiated with image exposure light by an image exposing unit 103 to form an electrostatic latent image on the surface of the electrophotographic photosensitive member 101. Then, development is performed with a toner supplied from a developing unit 104. As a result, a toner image is formed on the surface of the electrophotographic photosensitive member 101. Then, the toner image is transferred onto an intermediate transfer member 105 and secondarily transferred from the intermediate transfer member 105 onto a transfer material (not shown). Then, the toner image is fixed to the transfer material by a fixing unit (not shown).

The toner remaining on the surface of the electrophotographic photosensitive member 101 after the transfer of the toner image is removed by a cleaning unit 106. The cleaning unit 106 includes a rubbing roller 106a having an elastic sponge that rubs the electrophotographic photosensitive member 101 and a cleaning blade 106b. After that, the surface of the electrophotographic photosensitive member 101 is exposed to light by a pre-exposing unit 107 so that charge is eliminated from the electrophotographic photosensitive member 101. Image formation is continuously performed by repeating this series of processes.

The rubbing roller 106a is arranged in order to rub the surface of the electrophotographic photosensitive member 101 with the elastic sponge to actively remove a discharge product generated by charging.

In addition, the cleaning blade 106b is arranged in order to remove a residual toner by being brought into abutment against the electrophotographic photosensitive member 101.

### [Process Cartridge]

A process cartridge according to the present disclosure includes: an electrophotographic photosensitive member; a developing unit, which includes a toner, and which is configured to develop an electrostatic latent image formed on a surface of the electrophotographic photosensitive member with the toner to form a toner image on the surface of the electrophotographic photosensitive member; and a cleaning unit configured to remove a residual toner remaining on the surface of the electrophotographic photosensitive member after the toner image is transferred from the surface of the electrophotographic photosensitive member onto a transfer material, the process cartridge integrally supporting the electrophotographic photosensitive member, the developing unit, and the cleaning unit, and being detachably attachable onto a main body of an electrophotographic apparatus, wherein the surface of the electrophotographic photosensitive member is formed of amorphous silicon carbide, wherein a Si atom density in a region in the vicinity of the surface (surface region A) of the electrophotographic photosensitive member from the surface to a depth of 100 nm is 1.0×10²² atoms/cm³ or less, and wherein the toner contains a toner particle that contains a polyester resin having a polyethylene terephthalate segment and an inorganic fine particle.

In addition, the process cartridge according to the present disclosure may further include a charging unit configured to charge the surface of the electrophotographic photosensitive member in addition to the above-mentioned electrophotographic photosensitive member, developing unit, and cleaning unit.

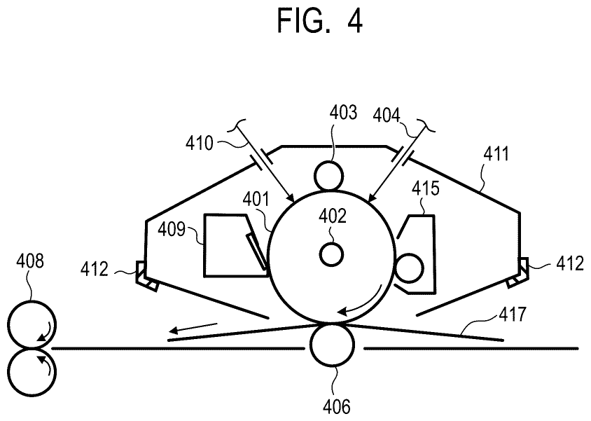

An example of a schematic configuration of an electrophotographic apparatus including a process cartridge that includes an electrophotographic photosensitive member is illustrated in FIG. 4.

In FIG. 4, a cylindrical electrophotographic photosensitive member 401 is driven to rotate at a predetermined peripheral speed in a direction indicated by the arrow around a shaft 402. During the rotation process, the surface (circumferential surface) of the electrophotographic photosensitive member 401 is charged positively or negatively by a charging unit (primary charging unit) 403. Then, the surface of the electrophotographic photosensitive member 401 is irradiated with exposure light (image exposure light) 404 emitted from an exposing unit (image exposing unit) (not shown). The exposure light 404 is intensity-modulated in response to a time-series electrical digital image signal of intended image information. Examples of the exposing unit include a slit exposing unit and a laser beam scanning exposing unit. Thus, an electrostatic latent image corresponding to the intended image information is formed on the surface of the electrophotographic photosensitive member 401.

The electrostatic latent image formed on the surface of the electrophotographic photosensitive member 401 is then developed (regular development or reversal development) with a toner accommodated in a developing unit 415 to form a toner image. The toner image formed on the surface of the electrophotographic photosensitive member 401 is transferred onto a transfer material 417 by a transfer unit 406. Here, when the transfer material 417 is paper, the transfer material 417 is taken out from a sheet feeding portion (not shown) in synchronization with the rotation of the electrophotographic photosensitive member 401 and fed between the electrophotographic photosensitive member 401 and the transfer unit 406. In addition, a bias voltage having polarity opposite to that of the charge retained by the toner is applied to the transfer unit 406 from a bias power supply (not shown). In addition, the transfer unit 406 may be a transfer unit of an intermediate transfer system including a primary transfer member, an intermediate transfer member, and a secondary transfer member.

The transfer material 417 having the toner image transferred thereonto is separated from the surface of the electrophotographic photosensitive member 401 and conveyed to a fixing unit 408. Then, the transfer material 417 undergoes fixing treatment for the toner image, and is printed outside the electrophotographic apparatus as an image-formed product (a print or a copy).

The surface of the electrophotographic photosensitive member 401 after the transfer of the toner image is cleaned by a cleaning unit 409 so that an adhering substance such as a transfer residual toner is removed. The transfer residual toner may be recovered by the developing unit 415 or the like. Further, as required, the surface of the electrophotographic photosensitive member 401 is subjected to charge-eliminating treatment by irradiation with pre-exposure light 410 from a pre-exposing unit (not shown), and is then repeatedly used for image formation. When the charging unit 403 is a contact charging unit using a charging member (charging roller) having a roller shape or the like, the pre-exposing unit is not necessarily required.

A plurality of elements are selected from the above-mentioned constituent elements, such as the electrophotographic photosensitive member 401, the charging unit 403, the developing unit 415, and the cleaning unit 409, and are accommodated in a container to form a process cartridge integrally supporting the elements. The process cartridge may be configured to be detachably attachable onto a main body of an electrophotographic apparatus, such as a copying machine or a laser beam printer. In FIG. 4, the electrophotographic photosensitive member 401, the charging unit 403, the developing unit 415, and the cleaning unit 409 are integrally supported to form a cartridge. Then, the cartridge is used as a process cartridge 411 that is detachably attachable onto a main body of an electrophotographic apparatus through use of a guiding unit 412 such as a rail of the main body of the electrophotographic apparatus.

### [Electrophotographic Photosensitive Member]

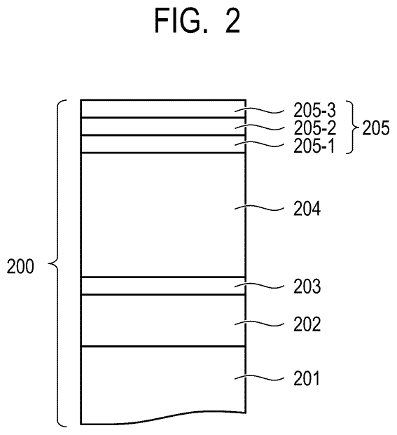

FIG. 2 is a schematic view for illustrating an example of a layer configuration of an a-Si photosensitive member to be used in the present disclosure.

A photosensitive member 200 illustrated in FIG. 2 includes a pressure-resistant layer 202, a charge injection blocking layer 203, a photoconductive layer 204, and a surface protective layer 205 on a conductive substrate 201.

Next, the conductive substrate and each layer for forming the photosensitive member having the above-mentioned layer configuration are described.

### (Conductive Substrate)

A material for the conductive substrate is desirably a material that forms a Schottky junction with the pressure-resistant layer formed directly on the surface of the conductive substrate. For example, when hydrogenated amorphous silicon nitride (hereinafter sometimes abbreviated as “a-SiN:H”) is applied as a material for the pressure-resistant layer, a material suitable for the conductive substrate is, for example, an alloy containing aluminum as a main component.

The surface of the conductive substrate may be roughened. It is only required that the surface roughness Sa of the conductive substrate be, for example, a surface roughness Sa of 80 nm or more and 120 nm or less after the roughening. This surface roughness is preferred because, for example, when a film is formed by a plasma CVD method, an electrophotographic photosensitive member in which the arithmetic average roughness Sa of the surface of the electrophotographic photosensitive member is 80 nm or more and 120 nm or less can be obtained.

As a method of roughening the surface of the conductive substrate, for example, wet blasting, sputter etching, gas etching, polishing, turning, wet etching, galvanic corrosion, or the like may be used. A drawn tube that satisfies the above-mentioned surface roughness may be used as it is without being subjected to surface treatment for adjusting the surface profile.

### (Pressure-Resistant Layer)

In an electrophotographic process, a voltage having polarity opposite to the charging polarity of the photosensitive member may be applied in a developing step, a transferring step, and the like. The pressure-resistant layer is a layer that suppresses the dielectric breakdown of the photosensitive member when a voltage having polarity opposite to the charging polarity of the photosensitive member is applied.

The pressure-resistant layer is preferably formed of hydrogenated amorphous silicon nitride (a-SiN:H).

### (Charge Injection Blocking Layer)

The charge injection blocking layer has a function to prevent electrons from being injected from the conductive substrate side into the photoconductive layer when the surface of the photosensitive member is positively charged.

The charge injection blocking layer is preferably formed of hydrogenated amorphous silicon (a-Si:H).

A material for the charge injection blocking layer is based on a material for forming the photoconductive layer, and contains a relatively large amount of atoms for controlling the conductivity of electrons as compared to the photoconductive layer.

In the photosensitive member to be used in the present disclosure, atoms belonging to Group 13 in the periodic table may be used as atoms incorporated into the charge injection blocking layer for controlling the conductivity of electrons. Of the atoms belonging to Group 13 in the periodic table, boron atoms (B), aluminum atoms (Al), and gallium atoms (Ga) are preferred.

The content of the atoms belonging to Group 13 in the periodic table incorporated into the charge injection blocking layer is preferably 1×10² atomic ppm or more and 3×10³ atomic ppm or less with respect to the content of silicon atoms (Si) contained the charge injection blocking layer.

The atoms belonging to Group 13 in the periodic table may be incorporated into the charge injection blocking layer in an evenly and uniformly distributed state, or there may be a portion in which the atoms are incorporated in a non-uniformly distributed state in a thickness direction. In any of the cases, it is preferred that the atoms for controlling the conductivity of electrons be incorporated into the charge injection blocking layer in a uniform distribution in an in-plane direction parallel to the surface of the substrate from the viewpoint of achieving uniform characteristics.

Further, when the charge injection blocking layer contains at least one kind of atoms among carbon atoms, nitrogen atoms, and oxygen atoms, adhesiveness between the charge injection blocking layer and the pressure-resistant layer can be improved.

### (Photoconductive Layer)

The photoconductive layer is preferably formed of hydrogenated amorphous silicon (a-Si:H). In addition, it is preferred that hydrogen atoms be incorporated into the photoconductive layer in order to compensate for dangling bonds.

In the present disclosure, it is preferred that the atoms for controlling the conductivity of electrons be incorporated into the photoconductive layer as required. The atoms for controlling the conductivity of electrons may be incorporated into the photoconductive layer in an evenly and uniformly distributed state, or there may be a portion in which the atoms are incorporated in a non-uniformly distributed state in the thickness direction.

Examples of the atoms for controlling the conductivity of electrons may include so-called impurities in the semiconductor field. That is, atoms belonging to Group 13 in the periodic table that impart p-type conductivity or atoms belonging to Group 15 in the periodic table that impart n-type conductivity may be used. Of the atoms belonging to Group 13 in the periodic table, boron atoms (B), aluminum atoms (Al), and gallium atoms (Ga) are preferred. Of the atoms belonging to Group 15 in the periodic table, phosphorus atoms (P) and arsenic atoms (As) are preferred.

The content of the atoms for controlling the conductivity of electrons incorporated into the photoconductive layer is preferably 1×10⁻² atomic ppm or more with respect to silicon atoms (Si). Meanwhile, the content is preferably 1×10 atomic ppm or less.

The photoconductive layer may be formed of a single layer or a plurality of layers (e.g., a charge generating layer and a charge transporting layer).

### (Surface Protective Layer)

The surface protective layer is formed of amorphous silicon carbide (including hydrogenated amorphous silicon carbide). It is preferred that the amorphous silicon carbide be hydrogenated (hydrogenated amorphous silicon carbide is hereinafter referred to as “a-SiC:H”).

In the photosensitive member for positive charging having the above-mentioned layer configuration, the surface protective layer also has a charge injection blocking function to prevent holes that are positive charge carriers from being injected into the photoconductive layer.

In addition, the surface protective layer may be formed of a plurality of layers, and in this case, as illustrated in FIG. 2, it is preferred that the surface protective layer include a first region 205-1, a second region 205-2, and a third region 205-3 in the stated order from the photoconductive layer side.

In the first region, the reflection of light that occurs at the interface between the photoconductive layer and the surface protective layer can be suppressed by changing the ratio of carbon atoms in stages or continuously.

In the second region, in order to increase the transmittance of the exposure light, the ratio of the number of carbon atoms to the total number of silicon atoms and the carbon atoms [C/(Si+C)] is preferably 0.50 or more and 0.80 or less.

The third region is a region to be an outermost region. From the viewpoint of durability, the thickness of the third region is preferably 150 nm or more.

In the present disclosure, the Si atom density in the region in the vicinity of the surface (surface region A) of the electrophotographic photosensitive member from the surface to a depth of 100 nm is 1.0×10²² atoms/cm³ or less. The Si atom density in the region in the vicinity of the surface (surface region A) of the electrophotographic photosensitive member from the surface to a depth of 100 nm may be set to 2.0×10²⁰ atoms/cm³ or more.

In addition, it is preferred that hydrogen atoms be incorporated into the surface region A in order to compensate for dangling bonds.

(Method of Producing a-Si Photosensitive Member in the Present Disclosure)

A method of producing the a-Si photosensitive member in the present disclosure may be any method as long as the method can form a layer that satisfies the above-mentioned conditions. Specific examples thereof include a plasma CVD method, a vacuum vapor deposition method, a sputtering method, and an ion plating method. Of those, a plasma CVD method is preferred from the viewpoint of, for example, ease of raw material supply.

A production apparatus and a production method each using the plasma CVD method are described below.

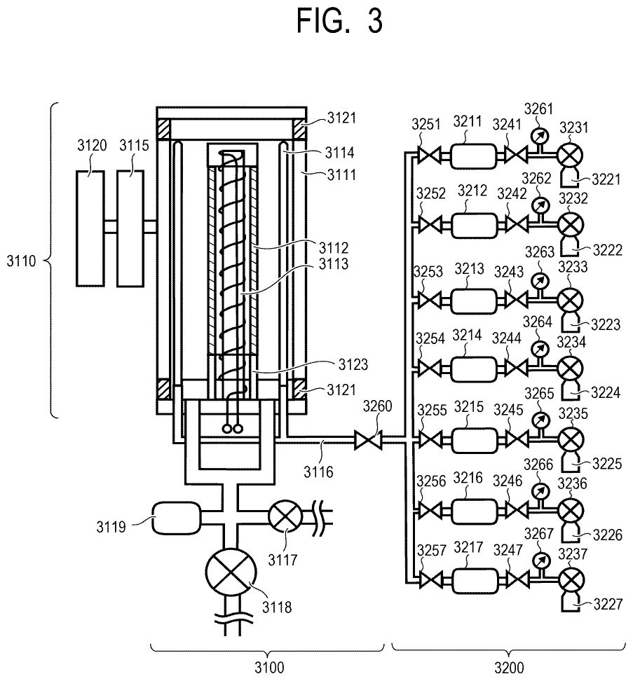

FIG. 3 is a view for schematically illustrating an example of a deposition apparatus using an RF plasma CVD method that uses a high-frequency power supply, which may be used for producing the a-Si photosensitive member in the present disclosure.

The deposition apparatus includes a deposition device 3100 including a reaction vessel 3110, a raw material gas supply device 3200, and an exhaust device (not shown) that reduces the pressure in the reaction vessel 3110 when broadly divided into devices.

In the reaction vessel 3110 in the deposition device 3100, a substrate 3112 connected to the ground, a substrate heating heater 3113, and a raw material gas-introducing tube 3114 are arranged. Further, a high-frequency power supply 3120 is connected to a cathode electrode 3111 through a high-frequency matching box 3115.

The raw material gas supply device 3200 includes raw material gas cylinders 3221 to 3227, valves 3231 to 3237, pressure regulators 3261 to 3267, inflow valves 3241 to 3247, and outflow valves 3251 to 3257. Further, the raw material gas supply device 3200 includes mass flow controllers 3211 to 3217. The raw material gas cylinders 3221 to 3227 in each of which a raw material gas is sealed are connected to the raw material gas-introducing tube 3114 in the reaction vessel 3110 through an auxiliary valve 3260. A gas piping line 3116, a leak valve 3117, and an insulating material 3121 are arranged.

Next, a method of forming a deposited film using the above-mentioned apparatus is described. First, the substrate 3112 that has been degreased and washed in advance is set in the reaction vessel 3110 via a receiving base 3123. Next, the exhaust device (not shown) is operated to exhaust the inside of the reaction vessel 3110. While a display of a vacuum gauge 3119 is monitored, when the pressure in the reaction vessel 3110 reaches a predetermined pressure of, for example, 1 Pa or less, power is supplied to the substrate heating heater 3113 to heat the substrate 3112 to a predetermined temperature of, for example, from 50° C. to 350° C. In this case, an inert gas, such as Ar or He, may be supplied from the raw material gas supply device 3200 to the reaction vessel 3110 to perform heating in an inert gas atmosphere.

Next, a gas to be used for forming a deposited film is supplied from the raw material gas supply device 3200 to the reaction vessel 3110. That is, the valves 3231 to 3237, the inflow valves 3241 to 3247, and the outflow valves 3251 to 3257 are opened as required, and the flow rate is set in the mass flow controllers 3211 to 3217. When the flow rate of each of the mass flow controllers becomes stable, the pressure in the reaction vessel 3110 is adjusted so as to be a desired pressure by operating a main valve 3118 while monitoring the display of the vacuum gauge 3119. When the desired pressure is obtained, high-frequency power is applied from the high-frequency power supply 3120, and simultaneously, the high-frequency matching box 3115 is operated to generate plasma discharge in the reaction vessel 3110. After that, the high-frequency power is promptly adjusted to desired power to form a deposited film.

When the formation of the predetermined deposited film is completed, the application of the high-frequency power is stopped, and the valves 3231 to 3237, the inflow valves 3241 to 3247, the outflow valves 3251 to 3257, and the auxiliary valve 3260 are closed to complete the supply of the raw material gas. Simultaneously, the main valve 3118 is fully opened to evacuate the inside of the reaction vessel 3110 to a pressure of 1 Pa or less.

The formation of the deposited film is completed as described. However, when a plurality of deposited films are formed, it is only required that the above-mentioned procedure be repeated again to form each layer. A junction region may also be formed by changing the raw material gas flow rate, the pressure, and the like in a certain period of time, for example, in accordance with the conditions for forming the photoconductive layer.

After the formation of all the deposited films is completed, the main valve 3118 is closed, and an inert gas is introduced into the reaction vessel 3110 to return the inside of the reaction vessel to an atmospheric pressure. Then, the substrate 3112 is removed.

In the formation of the pressure-resistant layer, for example, silanes, such as silane (SiH₄) and disilane (Si₂H₆), may each be suitably used as the raw material gas for supplying silicon atoms. In addition, as the raw material gas for supplying nitrogen atoms, for example, ammonia (NH₃) or nitrogen (N₂) may be suitably used. In addition, as the raw material gas for supplying oxygen atoms in the case of incorporating oxygen atoms, for example, oxygen (O₂) or nitrogen monoxide (NO) may be suitably used in addition to the above-mentioned raw material gases. In addition, as the raw material gas for supplying hydrogen atoms, for example, hydrogen (H₂) may be suitably used in addition to the above-mentioned raw material gases. In addition, when carbon atoms or the like are incorporated into the pressure-resistance layer in order to improve the adhesiveness with the conductive substrate, it is only required that a gaseous substance or a substance that can be easily gasified, containing the atoms to be incorporated, be appropriately used as the material.

In the formation of the charge injection blocking layer, in the same manner as described above, for example, silanes, such as silane (SiH₄) and disilane (Si₂H₆), may each be suitably used as the raw material gas for supplying silicon atoms. In addition, as the raw material gas for supplying atoms belonging to Group 13, for example, diborane (B₂H₆) may be suitably used. In addition, as the raw material gas for supplying hydrogen atoms, for example, hydrogen (H₂) may also be suitably used in addition to the above-mentioned raw material gases. In addition, when carbon atoms, oxygen atoms, nitrogen atoms, and the like are incorporated into the charge injection blocking layer in order to improve the adhesiveness with the pressure-resistant layer, it is only required that gaseous substances or substances that can be easily gasified, containing the respective atoms, be appropriately used as the materials.

In the formation of the photoconductive layer, in the same manner as described above, for example, silanes, such as silane (SiH₄) and disilane (Si₂H₆), may each be suitably used as the raw material gas for supplying silicon atoms. In addition, as the raw material gas for supplying hydrogen atoms, for example, hydrogen (H₂) may also be suitably used in addition to the above-mentioned silanes. In addition, when the atoms for controlling the conductivity of electrons, carbon atoms, oxygen atoms, nitrogen atoms, and the like are incorporated into the photoconductive layer, it is only required that gaseous substances or substances that can be easily gasified, containing the respective atoms, be appropriately used as the materials.

When a-SiC:H is formed as the surface protective layer, silanes, such as silane (SiH₄) and disilane (Si₂H₆), may each be suitably used as the raw material gas for supplying silicon atoms in the same manner as described above. In addition, as the raw material gas for supplying carbon atoms, for example, a gas, such as methane (CH₄) or acetylene (C₂H₂), may be suitably used. As the raw material gas for supplying hydrogen atoms, for example, hydrogen (H₂) may also be suitably used.

The composition and atom density of each layer may be changed by selecting the kind of the raw material gas, and the like. When the amount of the gas containing atoms for adjusting the atom density and component ratio is decreased, the atom density and component ratio in the layer can be decreased. In addition, examples of film formation parameters except the kind of the raw material gas include a substrate temperature, applied high-frequency power, addition of a diluent gas, a film formation pressure, and a film formation speed. In order to form a surface protective layer formed of amorphous silicon carbide, it is only required that the above-mentioned gas containing silicon atoms and gas containing carbon atoms (further, the above-mentioned gas containing hydrogen atoms, such as H₂, in the case of hydrogenated amorphous silicon carbide) be used for forming a deposited film of the surface protective layer.

### <Toner and Developer>

The toner to be used in the electrophotographic apparatus of the present disclosure is a toner containing a toner particle that contains a polyester resin having a polyethylene terephthalate segment and an inorganic fine particle.

The toner according to the present disclosure is described below.

### <Polyester Resin Having Polyethylene Terephthalate Segment>

The structure of the polyester resin incorporated into the toner in the present disclosure has a structure of polyethylene terephthalate. Examples of a component for forming the polyester resin having a polyethylene terephthalate segment include a polyethylene terephthalate segment, dihydric or higher alcohol monomer components, and acid monomer components, such as divalent or higher carboxylic acids, divalent or higher carboxylic anhydrides, and/or divalent or higher carboxylic acid esters.

### <Polyethylene Terephthalate Segment>

The polyethylene terephthalate segment of the present disclosure has a structure in which (C₁₀H₈O₄), which is a structural unit of polyethylene terephthalate, is repeated.

As the polyethylene terephthalate segment of the present disclosure, a polyethylene terephthalate segment that is produced by a condensation reaction or a transesterification reaction between ethylene glycol and terephthalic acid, dimethyl terephthalate, or the like in accordance with an ordinary method may be used. In addition, a recovered polyethylene terephthalate resin may also be used.

The polyethylene terephthalate resin is used in various products, such as a container and a film, and it is preferred that the polyethylene terephthalate resin be recovered to be reused from the viewpoint of environmental protection. The kind of the recovered polyethylene terephthalate resin is not limited as long as the resin has an appropriate level of purity without containing impurities that influence toner characteristics and reactions in the production process.

### <Dihydric or Higher Alcohol Monomer Component>

Examples of the dihydric or higher alcohol monomer component include: alkylene oxide adducts of bisphenol A, such as polyoxypropylene (2.2)-2,2-bis(4-hydroxyphenyl) propane, polyoxypropylene (3.3)-2,2-bis(4-hydroxyphenyl) propane, polyoxyethylene (2.0)-2,2-bis(4-hydroxyphenyl) propane, polyoxypropylene (2.0)-polyoxyethylene (2.0)-2,2-bis(4-hydroxyphenyl) propane, and polyoxypropylene (6)-2,2-bis(4-hydroxyphenyl) propane; and ethylene glycol, 1,2-propylene glycol, 1,4-butanediol, neopentyl glycol, polyethylene glycol, and polypropylene glycol.

### <Acid Monomer Component>

Meanwhile, examples of the acid monomer component, such as a divalent or higher carboxylic acid, a divalent or higher carboxylic acid anhydride, and a divalent or higher carboxylic acid ester, include: aromatic dicarboxylic acids, such as phthalic acid, isophthalic acid, and terephthalic acid, or anhydrides thereof; and alkyl dicarboxylic acids, such as oxalic acid, malonic acid, succinic acid, adipic acid, maleic acid, fumaric acid, citraconic acid, and itaconic acid, or anhydrides thereof.

### <Production Method for Polyester Resin Having Polyethylene Terephthalate Segment>

The polyester resin having a polyethylene terephthalate segment in the present disclosure may be produced in accordance with an ordinary polyester synthesis method. For example, a desired polyester resin may be obtained by subjecting a carboxylic acid monomer and an alcohol monomer to an esterification reaction or a transesterification reaction, and then subjecting the resultant to a polycondensation reaction in accordance with an ordinary method under reduced pressure or while introducing a nitrogen gas.

### <Amorphous Resin a, Crystalline Polyester Resin C, and Phosphorus Compound>

Further, it is more preferred that the following toner be used because low-temperature fixability and scratch resistance can be improved.

A toner having a toner particle containing a binder resin, wherein the binder resin contains an amorphous resin A and a crystalline polyester resin C, wherein the amorphous resin A is a polyester resin, and the amorphous resin A has, as structures for forming a polyester backbone,
(i) a polyethylene terephthalate segment, and
(ii) at least one structure selected from the group consisting of: a structure represented by the following formula (1); a structure represented by the following formula (2); a structure represented by the following formula (3); and a structure represented by the following formula (4):

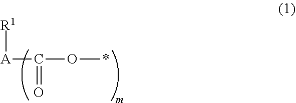

in the formula (1), R¹ represents an alkyl group having 6 to 16 carbon atoms or an alkenyl group having 6 to 16 carbon atoms, A represents a hydrocarbon group, “*” represents a bonding site in the polyester backbone, and “m” represents an integer of 2 or more;

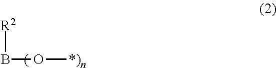

in the formula (2), R² represents an alkyl group having 6 to 16 carbon atoms or an alkenyl group having 6 to 16 carbon atoms, B represents a hydrocarbon group, “*” represents a bonding site in the polyester backbone, and “n” represents an integer of 2 or more;

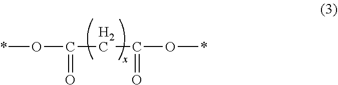

in the formula (3), “*” represents a bonding site in the polyester backbone, and “x” represents an integer of from 6 to 16,

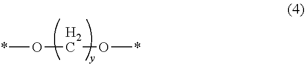

in the formula (4), “*” represents a bonding site in the polyester backbone, and “y” represents an integer of from 6 to 16,
wherein, when an SP value of the amorphous resin A is represented by SP_{A} (cal/cm³)^{0.5}, and an SP value of the crystalline polyester resin C is represented by SP_{C} (cal/cm³)^{0.5}, the SP_{A} and the SP_{C} satisfy the following formula (C):

$$1. \leq {SP}_{A} - {SP}_{C} \leq 1.35 , \qquad ( C )$$

wherein the toner contains a phosphorus element derived from a phosphorus compound, and wherein, when a content of the phosphorus element in the toner based on a mass of the toner is represented by W_{P} (mass ppm), the W_{P} satisfies the following formula (D):

$$5 \leq {W}_{P} \leq 500. \qquad ( D )$$

In addition, the W_{P} may satisfy the following formula (E):

$$20 \leq {W}_{P} \leq 500. \qquad ( E )$$

The reason for the improvement of low-temperature fixability and scratch resistance is described below.

Investigations made by the inventors have found that the toner having the characteristics as described below improves scratch resistance while exhibiting satisfactory low-temperature fixability.
(i) A three-dimensional structure can be flexibly deformed in a direction in which external force is applied.
(ii) When the external force is removed, an original three-dimensional structure can be recovered.

Such toner can be achieved by the above-mentioned configuration.

The amorphous resin A in the present disclosure has at least one structure selected from the group consisting of: the structure represented by the formula (1); the structure represented by the formula (2); the structure represented by the formula (3); and the structure represented by the formula (4), and the SP values of the amorphous resin A and the crystalline polyester resin C are controlled. As a result, the amorphous resin A has affinity for the crystalline polyester resin C. Thus, in a fixed image, the amorphous resin A is influenced by the crystalline polyester resin C to become flexible. In addition, this structure disperses the applied external force, and hence the three-dimensional structure can be flexibly deformed in the direction in which the external force is applied without a molecular chain being broken.

In addition, the amorphous resin A contains a polyethylene terephthalate segment and hence has a repeating structure of a condensate of terephthalic acid and ethylene glycol in a polyester backbone. In the structure derived from the ethylene glycol of the polyethylene terephthalate segment, both terminals of the ethylene glycol are subjected to an esterification reaction, and hence the structure has ester groups at a significantly close molecular distance corresponding to two carbon atoms. Thus, the amorphous resin A has ester groups localized in the resin.

In addition, the phosphorus compound in which three unshared electron pairs in an outermost shell are caused to react also has bonding points at a significantly close molecular distance. As a result, the amorphous resin A can interact with the ester groups localized in the amorphous resin A around phosphorus elements of the phosphorus compound, thereby being capable of forming a three-dimensional crosslinked structure. By virtue of the presence of this structure, when the applied external force is removed, the deformed state can be returned to the original three-dimensional structure. As described above, it is conceived that the configuration of the present disclosure enables excellent low-temperature fixability and scratch resistance to be obtained.

The amorphous resin A in the present disclosure has at least one structure selected from the group consisting of: the structure represented by the formula (1); the structure represented by the formula (2); the structure represented by the formula (3); and the structure represented by the formula (4) as a structure for forming the polyester backbone. The structure of a long-chain hydrocarbon group, such as an alkyl group or an alkenyl group, in each of the above-mentioned structures becomes a structure having relatively low polarity as compared to the above-mentioned structure derived from the ethylene glycol of the polyethylene terephthalate segment. As a result, the structure of a long-chain hydrocarbon group, such as an alkyl group or an alkenyl group, in each of the structures becomes flexible when the affinity for the crystalline polyester resin C is increased. In addition, this structure disperses the applied external force, and hence the three-dimensional structure can be flexibly deformed in the direction in which the external force is applied without a molecular chain being broken. As a result, the improvement of elastic deformation is achieved to provide excellent scratch resistance.

In addition, the SP_{A} (cal/cm³)^{0.5} of the amorphous resin A and the SP_{C} (cal/cm³)^{0.5} of the crystalline polyester resin C in the present disclosure satisfy the formula (C). When SP_{A}-SP_{C} satisfies the formula (C), the amorphous resin A and the crystalline polyester resin C are easily become compatible, and hence the crystalline polyester resin C can smoothly work on the structure of the amorphous resin A having a long-chain hydrocarbon group, such as an alkyl group or an alkenyl group. As a result, this structure becomes flexible when the affinity for the crystalline polyester resin C is increased. In addition, this structure disperses the applied external force, and hence the three-dimensional structure can be flexibly deformed in the direction in which the external force is applied without a molecular chain being broken. As a result, the improvement of elastic deformation characteristics is achieved to provide excellent scratch resistance.

Further, the toner of the present disclosure contains phosphorus elements derived from the phosphorus compound, and W_{P} (mass ppm) satisfies the formula (D). When the content of the phosphorus elements in the toner satisfies the formula (D), this case indicates that the phosphorus elements are present in an amount sufficient for an interaction with the ester groups localized in the amorphous resin A around the phosphorus elements to form a three-dimensional crosslinked structure. That is, the above-mentioned content allows the applied external force to be dispersed, and hence corresponds to the minimum amount of the phosphorus elements that can flexibly change the three-dimensional structure in the direction in which the external force is applied without breakage of the molecular chain and the maximum amount of the phosphorus elements that can ensure a certain degree of plastic deformation capable of ensuring low-temperature fixability.

### <Amorphous Resin A>

The amorphous resin A is a polyester resin that has the following (i) and (ii) as structures for forming the polyester backbone:
(i) a polyethylene terephthalate segment; and
(ii) at least one structure selected from the group consisting of: the structure represented by the formula (1); the structure represented by the formula (2); the structure represented by the formula (3); and the structure represented by the formula (4).

The polyethylene terephthalate segment to be used in the amorphous resin A is obtained by subjecting ethylene glycol and terephthalic acid to polycondensation.

In addition, the synthesis of the amorphous resin A may be performed in an inert gas atmosphere, preferably in the presence of an esterification catalyst, and further as required, in the presence of an esterification promoter, a polymerization inhibitor, and the like, preferably at a temperature of 180° C. or more and 250° C. or less.

Examples of the esterification catalyst include a tin compound, such as dibutyltin oxide or tin (II) 2-ethylhexanoate, and a titanium compound such as titanium diisopropylate bistriethanolaminate. Of those, a tin compound such as tin (II) 2-ethylhexanoate is preferred. The usage amount of the esterification catalyst is preferably 0.01 part by mass or more, more preferably 0.1 part by mass or more and preferably 1.5 parts by mass or less, more preferably 1.0 part by mass or less with respect to 100 parts by mass of the raw material monomers (an alcohol component, a carboxylic acid component, and PET). An example of the esterification promoter is gallic acid. The usage amount of the esterification promoter is preferably 0.001 part by mass or more, more preferably 0.01 part by mass or more and preferably 0.5 part by mass or less, more preferably 0.1 part by mass or less with respect to 100 parts by mass of the raw material monomers. An example of the polymerization inhibitor is tert-butyl catechol. The usage amount of the polymerization inhibitor is preferably 0.001 part by mass or more, more preferably 0.01 part by mass or more and preferably 0.5 part by mass or less, more preferably 0.1 part by mass or less with respect to 100 parts by mass of the raw material monomers.

In addition, in the synthesis of the amorphous resin A, the polyethylene terephthalate may be allowed to be present from the start of the polycondensation reaction, or may be added to the reaction system during the polycondensation reaction. In order for the polyethylene terephthalate segment to be incorporated into the main backbone of the amorphous resin A in a block form to a certain extent, the timing of the addition of the polyethylene terephthalate is preferably in a stage in which the reaction rate of the alcohol component and the carboxylic acid component is 10% or less, more preferably in a stage in which the reaction rate is 5% or less. Here, the reaction rate refers to the value of generated reaction water amount (mol)/theoretical generated water amount (mol)×100.

In addition, as the polyethylene terephthalate segment to be incorporated into the amorphous resin A, spent polyethylene terephthalate (so-called regenerated PET) may be used. It is preferred that the polyethylene terephthalate be reused from the viewpoint of the environment.

The spent PET is recovered. The recovered PET is washed and sorted so as to be prevented from being mixed with other materials and dust. After a label and the like are removed, the resultant is pulverized into flakes or the like. The pulverized product may be used as it is, or the pulverized product, which is kneaded and coarsely pulverized, may also be used. When the chemical substances adsorbed to the surface of a PET bottle cannot be sufficiently removed by ordinary washing, alkali washing may be performed. When part of the pulverized product is hydrolyzed by the alkali washing, it is preferred that the washed pulverized product, which is melted and pelletized, be subjected to solid phase polymerization in order to restore the reduced polymerization degree. The solid-phase polymerization step may be performed by subjecting the washed flakes or the flakes, which are melted and extruded into pellets, to continuous solid-phase polymerization in an inert gas, such as a nitrogen gas or a noble gas, at a temperature of from 180° C. to 245° C., preferably from 200° C. to 240° C. In addition, the washed pulverized product, which is decomposed to a monomer unit by depolymerization and resynthesized, may also be used. In addition, the regenerated PET is not limited to the above-mentioned spent PET, and fiber scraps or pellets of off-spec PET discharged from factories may also be used.

In addition, in order to incorporate at least one structure selected from the group consisting of: the structure represented by the formula (1); the structure represented by the formula (2); the structure represented by the formula (3); and the structure represented by the formula (4) into the amorphous resin A, the following monomers may be used. Examples thereof include 1,6-hexanediol, 1,7-heptanediol, 1,8-octanediol, 1,9-nonanediol, 1,10-decanediol, 1,11-undecanediol, 1,12-dodecanediol, suberic acid, azelaic acid, sebacic acid, undecanedioic acid, dodecanedioic acid, tetradecanedioic acid, hexadecanedioic acid, octadecanedioic acid, dodecenylsuccinic acid, n-octylsuccinic acid, isododecenylsuccinic acid, dodecylsuccinic acid, isooctenylsuccinic acid, and hexadecylsuccinic acid.

Of the above-mentioned respective structures, the amorphous resin A preferably contains the structure represented by the formula (1) or the structure represented by the formula (2). The alkyl group or alkenyl group having 6 to 16 carbon atoms is branched from the main chain of the polyester backbone. Thus, the affinity for a release agent is enhanced, and the dispersibility of the release agent is further enhanced.

In addition, as a component for obtaining the amorphous resin A, other polyhydric alcohols (dihydric or higher alcohols) or polyvalent carboxylic acids (divalent or higher carboxylic acids), and acid anhydrides or lower alkyl esters thereof may each be used in addition to the above-mentioned structures and monomers.

The following polyhydric alcohol monomers may each be used as a polyhydric alcohol monomer. As a dihydric alcohol component, there are given, for example: ethylene glycol, propylene glycol, 1,3-butanediol, 1,4-butanediol, 2,3-butanediol, diethylene glycol, triethylene glycol, neopentyl glycol, 2-ethyl-1,3-hexanediol, hydrogenated bisphenol A, a bisphenol represented by the following formula (F) and derivatives thereof, and diols each represented by the following formula (G):

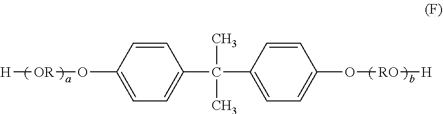

in the formula (F), R represents an ethylene group or a propylene group, “a” and “b” each represent an integer of 0 or more, and the average of a+b is 0 or more and 10 or less;

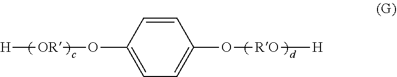

in the formula (G), R′represents an ethylene group, —CH₂CH(CH₃)— or —CH₂C(CH₃)₂—, “c” and “d” each represent an integer of 0 or more, and the average of c+d is 0 or more and 10 or less.

As a trihydric or higher alcohol component, there are given, for example, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene. Of those, glycerol, trimethylolpropane, and pentaerythritol are preferably used.

Those dihydric alcohols and trihydric or higher alcohols may be used alone or in combination thereof.

As a divalent carboxylic acid component, there are given, for example, maleic acid, fumaric acid, citraconic acid, itaconic acid, glutaconic acid, phthalic acid, isophthalic acid, terephthalic acid, succinic acid, azelaic acid, malonic acid, and anhydrides of those acids and lower alkyl esters thereof. Of those, maleic acid, fumaric acid, and terephthalic acid are preferably used.

Examples of the trivalent or higher carboxylic acid, the acid anhydride thereof, or the lower alkyl ester thereof include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, EMPOL trimer acid, and acid anhydrides thereof or lower alkyl esters thereof. Of those, 1,2,4-benzenetricarboxylic acid, that is, trimellitic acid or a derivative thereof is particularly preferably used because trimellitic acid or the derivative thereof is available at low cost and its reaction can be easily controlled. Those divalent carboxylic acids and trivalent or higher carboxylic acids may be used alone or in combination thereof.

A method of producing the amorphous resin A is not particularly limited, and a known method may be used. For example, the amorphous resin A is produced by simultaneously loading the above-mentioned alcohol monomer and carboxylic acid monomer and then polymerizing the mixture through an esterification reaction or a transesterification reaction and a condensation reaction. In addition, the polymerization temperature is not particularly limited, but a range of 180° C. or more and 290° C. or less is preferred. In the polymerization of a polyester unit, a polymerization catalyst, such as a titanium-based catalyst, a tin-based catalyst, zinc acetate, antimony trioxide, or germanium dioxide, may be used. In particular, the amorphous resin A is more preferably a polyester resin polymerized through use of a tin-based catalyst.

The amorphous resin A may be a polyester resin having a vinyl-based resin portion. As a method of obtaining a polyester resin having a vinyl-based resin bonded thereto, a method involving using a monomer component that may react with both the vinyl-based resin and the polyester unit is preferred. As such monomer, a monomer having an unsaturated double bond and a carboxy group or a hydroxy group is preferred. Examples thereof include unsaturated dicarboxylic acids, such as phthalic acid, maleic acid, citraconic acid, and itaconic acid, or anhydrides thereof, and acrylic acid or methacrylic acid esters.

In addition, the peak molecular weight of the amorphous resin A is preferably 3,500 or more and 20,000 or less from the viewpoint of, for example, low-temperature fixability. The glass transition temperature is preferably from 40° C. to 70° C.

In addition, as an amorphous resin, various resins that have hitherto been known as binder resins may each be used in combination with the amorphous resin A. Examples of such resin include a phenol resin, a natural resin-modified phenol resin, a natural resin-modified maleic resin, an acrylic resin, a methacrylic resin, a polyvinyl acetate resin, a silicone resin, a polyester resin, a polyurethane resin, a polyamide resin, a furan resin, an epoxy resin, a xylene resin, a polyvinyl butyral resin, a terpene resin, a coumarone-indene resin, and a petroleum-based resin.

### <Crystalline Polyester Resin C>

A polyhydric alcohol (dihydric or trihydric or higher alcohol), and a polyvalent carboxylic acid (divalent or trivalent or higher carboxylic acid), an acid anhydride thereof, or a lower alkyl ester thereof are used as the monomers to be used for the polyester unit of the crystalline polyester resin C to be used in the toner of the present disclosure.

The following polyhydric alcohol monomers may each be used as a polyhydric alcohol monomer to be used for the polyester unit of the crystalline polyester resin C.

The polyhydric alcohol monomer is not particularly limited, but is preferably a chain (more preferably straight-chain) aliphatic diol. Examples thereof include ethylene glycol, diethylene glycol, triethylene glycol, 1,2-propylene glycol, 1,3-propylene glycol, 1,6-hexanediol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. Of those, straight-chain aliphatic α,ω-diols, such as ethylene glycol, diethylene glycol, 1,4-butanediol, and 1,6-hexanediol, are particularly preferred examples.

In the present disclosure, a polyhydric alcohol monomer except the above-mentioned polyhydric alcohols may also be used. Examples of a dihydric alcohol monomer out of the polyhydric alcohol monomers include: an aromatic alcohol, such as polyoxyethylenated bisphenol A or polyoxypropylenated bisphenol A; and 1,4-cyclohexanedimethanol. In addition, examples of a trihydric or higher polyhydric alcohol monomer out of the polyhydric alcohol monomers include: an aromatic alcohol such as 1,3,5-trihydroxymethylbenzene; and an aliphatic alcohol, such as pentaerythritol, dipentaerythritol, tripentaerythritol, 1,2,4-butanetriol, 1,2,5-pentanetriol, glycerin, 2-methylpropanetriol, 2-methyl-1,2,4-butanetriol, trimethylolethane, or trimethylolpropane.

The following polyvalent carboxylic acid monomers may each be used as a polyvalent carboxylic acid monomer to be used for the polyester unit of the crystalline polyester resin C.

The polyvalent carboxylic acid monomer is not particularly limited, but is preferably a chain (more preferably straight-chain) aliphatic dicarboxylic acid. Specific examples thereof include: oxalic acid, malonic acid, succinic acid, glutaric acid, adipic acid, pimelic acid, suberic acid, glutaconic acid, azelaic acid, sebacic acid, nonanedicarboxylic acid, decanedicarboxylic acid, undecanedicarboxylic acid, dodecanedicarboxylic acid, maleic acid, fumaric acid, mesaconic acid, citraconic acid, and itaconic acid; and products obtained by hydrolyzing acid anhydrides or lower alkyl esters thereof.

In the present disclosure, a polyvalent carboxylic acid except the above-mentioned polyvalent carboxylic acid monomers may also be used. Examples of a divalent carboxylic acid out of the other polyvalent carboxylic acid monomers include: an aromatic carboxylic acid, such as isophthalic acid or terephthalic acid; an aliphatic carboxylic acid, such as n-dodecylsuccinic acid or n-dodecenylsuccinic acid; an alicyclic carboxylic acid such as cyclohexanedicarboxylic acid; and acid anhydrides or lower alkyl esters thereof. In addition, examples of a trivalent or higher polyvalent carboxylic acid out of the other carboxylic acid monomers include: an aromatic carboxylic acid, such as 1,2,4-benzenetricarboxylic acid (trimellitic acid), 2,5,7-naphthalenetricarboxylic acid, 1,2,4-naphthalenetricarboxylic acid, or pyromellitic acid; an aliphatic carboxylic acid, such as 1,2,4-butanetricarboxylic acid, 1,2,5-hexanetricarboxylic acid, or 1,3-dicarboxy-2-methyl-2-methylenecarboxypropane; and derivatives, such as acid anhydrides or lower alkyl esters, thereof.

In addition, the crystalline polyester resin C is preferably a modified crystalline polyester resin having a structure in which a hydroxy group at a main chain terminal is terminally modified with an aliphatic monocarboxylic acid having 16 to 31 carbon atoms, or a modified crystalline polyester resin having a structure in which a carboxy group at a main chain terminal is terminally modified with an aliphatic monoalcohol having 15 to 30 carbon atoms.

Examples of the aliphatic monocarboxylic acid monomer having 16 to 31 carbon atoms include palmitic acid (hexadecanoic acid), margaric acid (heptadecanoic acid), stearic acid (octadecanoic acid), nonadecylic acid, arachidic acid (icosanoic acid), henicosanoic acid, docosanoic acid, tetracosanoic acid, hexacosanoic acid, octacosanoic acid, and triacontanoic acid.

Examples of the aliphatic monoalcohol having 15 to 30 carbon atoms include cetyl alcohol, palmityl alcohol (hexadecanol), margaryl alcohol (heptadecanol), stearyl alcohol (octadecanol), nonadecanol, arachidyl alcohol (icosanol), heneicosanol, behenyl alcohol, lignoceryl alcohol, ceryl alcohol, 1-heptacosanol, montanyl alcohol, 1-nonacosanol, and myricyl alcohol.

The crystalline polyester resin C may be produced in accordance with an ordinary polyester synthesis method. For example, the crystalline polyester resin may be obtained by: subjecting the carboxylic acid monomer and alcohol monomer described above to an esterification reaction or a transesterification reaction; and then subjecting the resultant to a polycondensation reaction in accordance with an ordinary method under reduced pressure or while introducing a nitrogen gas. After that, a desired crystalline polyester resin is obtained by further adding the above-mentioned aliphatic compound and performing an esterification reaction.

The esterification or transesterification reaction may be performed with a general esterification catalyst or transesterification catalyst, such as sulfuric acid, titanium butoxide, dibutyltin oxide, manganese acetate, or magnesium acetate, as required.

In addition, the polycondensation reaction may be performed with a known catalyst, for example, an ordinary polymerization catalyst, such as titanium butoxide, dibutyltin oxide, tin acetate, zinc acetate, tin disulfide, antimony trioxide, or germanium dioxide. A polymerization temperature and a catalyst amount are not particularly limited, and may be appropriately determined.

In the esterification or transesterification reaction, or the polycondensation reaction, the following method may be used: all the monomers are collectively loaded in order to improve the strength of the crystalline polyester resin to be obtained. In addition, for example, the following method may be used: the divalent monomers are caused to react with each other first, and then a monomer that is trivalent or more is added to, and caused to react with, the resultant, in order to reduce the amount of a low-molecular weight component.

The melting point of the crystalline polyester resin C is preferably from 70° C. to 110° C., more preferably from 80° C. to 100° C. from the viewpoint of low-temperature fixability. In the toner of the present disclosure, it is preferred that the crystalline polyester resin C be used in an amount of from 3 parts by mass or more and 20 parts by mass or less with respect to 100 parts by mass of the amorphous resin from the viewpoints of low-temperature fixability, scratch resistance, and a chargeability maintaining property under a high-temperature and high-humidity environment.

### <Phosphorus Compound>

Examples of the phosphorus compound to be used for the toner of the present disclosure include trisodium phosphate, trimethyl phosphate, triethyl phosphate, tri-2-ethylhexyl phosphate, tris(isopropylphenyl) phosphate, triphenyl phosphate, tributyl phosphate, trimethyl phosphite, tributyl phosphite, and triphenyl phosphite. Of those, a trivalent phosphorus compound that easily forms a three-dimensional crosslink is preferred.

The optimal W_{P} for forming a three-dimensional crosslinked structure is as described above. Further, when the toner contains spent polyethylene terephthalate (so-called regenerated PET), the block of polyethylene terephthalate is easily formed, and hence the ester groups at a close molecular distance can be more easily assembled to form a strong three-dimensional crosslinked structure. This structure can be returned to an original three-dimensional structure when the applied external force is removed.

### <Inorganic Fine Particle>

The toner contains an inorganic fine particle.

When the toner contains an inorganic fine particle, the inorganic fine particle is supplied to a nip portion between a portion to be cleaned of a photosensitive member and a cleaning blade at the time of repeated use of an electrophotographic apparatus to stabilize the cleaning, and thus the occurrence of a streak-like image defect is suppressed.

Examples of the inorganic fine particle include fine particles, such as a silica fine particle, a titanium oxide fine particle, an alumina fine particle, and a complex oxide fine particle thereof. Of the inorganic fine particles, a silica fine particle and a titanium oxide fine particle are preferred because of fluidity improvement and charging uniformity.

The inorganic fine particle is preferably hydrophobized with a hydrophobizing agent, such as a silane compound, a silicone oil, or a mixture thereof.

### <Release Agent>

The toner particle may contain a wax as a release agent. Examples of the wax include a polyethylene wax, a polypropylene wax, a polypropylene copolymer wax, a microcrystalline wax, a paraffin wax, a Fischer-Tropsch wax, a carnauba wax, a rice wax, a candelilla wax, and a montan wax.

### <Colorant>

The toner may contain a colorant. Examples of the colorant include known organic pigments or oil-based dyes, and magnetic materials. Examples of the colorant include carbon black, Phthalocyanine Blue, Permanent Brown FG, Brilliant Fast Scarlet, Pigment Red 122, Pigment Green B, Rhodamine-B base, Solvent Red 49, Solvent Red 146, Solvent Blue 35, quinacridone, Carmine 6B, isoindoline, Disazo Yellow, Benzidine Yellow, a monoazo-based dye or pigment, and a disazo-based dye or pigment.

### <Charge Control Agent>

The toner particle may contain a charge control agent as required. A known charge control agent may be used as the charge control agent, but it is preferred to use a positive charge control agent, in particular, when used in combination with the photosensitive member used in the present disclosure.

Examples of the positive charge control agent include a quaternary ammonium salt compound, a triphenylmethane compound, an imidazole compound, and a nigrosine dye.

As a negative charge control agent, there are given, for example: a salicylic acid metal compound; a naphthoic acid metal compound; a dicarboxylic acid metal compound; a polymer-type compound having a sulfonic acid or a carboxylic acid in a side chain thereof; a polymer-type compound having a sulfonate or a sulfonic acid esterified product in a side chain thereof; a polymer-type compound having a carboxylate or a carboxylic acid esterified product in a side chain thereof; a boron compound; a urea compound; a silicon compound; and a calixarene.

### <External Additive>

In addition to the above-mentioned inorganic fine particle, an organic fine particle, such as a melamine-based resin fine particle and a polytetrafluoroethylene resin fine particle, may be used as the external additive.

From the viewpoint of improving fluidity, the number-based median diameter (D₅₀) of the external additives is preferably 10 nm or more and preferably 250 nm or less, more preferably 200 nm or less, still more preferably 90 nm or less.

The content of the external additive is preferably from 0.1 part by mass to 10.0 parts by mass with respect to 100 parts by mass of the toner particle. A known mixer such as a Henschel mixer may be used in the mixing of the toner particle and the external additive.

### <Method of Producing Toner Particle>

A method of producing the toner particle is not particularly limited, and known methods, such as a pulverization method, a suspension polymerization method, a dissolution suspension method, an emulsion aggregation method, and a dispersion polymerization method, may be used. Of those, a pulverization method is preferred from the viewpoint of controlling the wax on the surface of the toner particle. That is, the toner particle is preferably a pulverized toner particle. A toner production procedure in the pulverization method is described below.

The pulverization method includes, for example: a raw material-mixing step of mixing the crystalline polyester resin C and the amorphous resin A serving as binder resins, a phosphorus compound, and other components, such as other amorphous resins, a wax, a colorant, and a charge control agent, as required; a step of melt-kneading the mixed raw materials to provide a resin composition; and a step of pulverizing the resultant resin composition to provide a toner particle.

In the raw material-mixing step, predetermined amounts of, for example, the binder resin, the wax, and as required, any other components, such as the colorant and the charge control agent, serving as constituent materials for the toner particle are weighed, and the materials are blended and mixed. An example of a mixing apparatus is a double cone mixer, a V-type mixer, a drum-type mixer, a super mixer, a Henschel mixer, a Nauta mixer, or MECHANO HYBRID (manufactured by Nippon Coke & Engineering Co., Ltd.).

Next, the mixed materials are melt-kneaded to disperse the materials in the binder resin. In the melt-kneading step, a batch-type kneader, such as a pressure kneader or a Banbury mixer, or a continuous kneader may be used, and a single-screw or twin-screw extruder has been in the mainstream because of the following superiority: the extruder can perform continuous production. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Ironworks Corp.), a twin-screw extruder (manufactured by K.C.K.), a co-kneader (manufactured by Buss), and KNEADEX (manufactured by Nippon Coke & Engineering Co., Ltd.). Further, a resin composition obtained by the melt-kneading may be rolled with a twin-roll mill or the like, and may be cooled with water or the like in a cooling step.

Next, the cooled product of the resin composition is pulverized into a desired particle diameter in a pulverizing step. In the pulverizing step, the cooled product is first coarsely pulverized with a pulverizer, such as a crusher, a hammer mill, or a feather mill. Then, the cooled product is finely pulverized with, for example, KRYPTRON SYSTEM (manufactured by Kawasaki Heavy Industries, Ltd.), SUPER ROTOR (manufactured by Nisshin Engineering Inc.), TURBO MILL (manufactured by Turbo Kogyo Co., Ltd.), or a fine pulverizer based on an air jet system.

After that, as required, the finely pulverized product is classified with a classifier or a sifter, such as: ELBOW-JET (manufactured by Nittetsu Mining Co., Ltd.) based on an inertial classification system, or TURBOPLEX (manufactured by Hosokawa Micron Corporation), TSP SEPARATOR (manufactured by Hosokawa Micron Corporation), or FACULTY (manufactured by Hosokawa Micron Corporation) based on a centrifugal force classification system.

After that, the surface of the toner particle is subjected to external addition treatment with an external additive such as a silica fine particle as required to provide a toner. As an apparatus for performing the external addition treatment, there is given a mixing apparatus, such as a double cone mixer, a V-type mixer, a drum-type mixer, a super mixer, a Henschel mixer, a Nauta mixer, MECHANO HYBRID (manufactured by Nippon Coke & Engineering Co., Ltd.), or NOBILTA (manufactured by Hosokawa Micron Corporation).

Methods of measuring various physical properties are described below.

(Method of Separating Each Material from Toner)

Each of the materials in the toner may be separated from the toner through utilization of differences between the solubilities of the materials in the toner in solvents and GPC. The following various physical properties can be measured through use of each separated material.

First separation: The toner is dissolved in methyl ethyl ketone (MEK) at 23° C. to be separated into soluble matter (the amorphous resin A, the other amorphous resins, the crystalline polyester resin C, and the phosphorus compound) and insoluble matter (the wax, the colorant, the inorganic fine particle, and the like).

Second separation: The soluble matter (the amorphous resin A, the other amorphous resin, the crystalline polyester resin C, and the phosphorus compound) obtained in the first separation is dissolved in tetrahydrofuran (THF) at 23° C. to be separated into soluble matter (the amorphous resin A, the other amorphous resin, and the phosphorus compound) and insoluble matter (the crystalline polyester resin C).

Third separation: The insoluble matter (the wax, the colorant, the inorganic fine particle, and the like) obtained in the first separation is dissolved in MEK at 100° C. to be separated into soluble matter (the wax) and insoluble matter (the colorant, the inorganic fine particle, and the like).

Fourth separation: The soluble matter (the amorphous resin A, the other amorphous resin, and the phosphorus compound) obtained in the second separation is dissolved in tetrahydrofuran (THF) at 23° C. to be separated into the amorphous resin A, the other amorphous resin, and the phosphorus compound by preparative GPC.

### <Identification of Attribution of Various Monomer Units in Amorphous Resin and Crystalline Polyester Resin, and Measurement Method for Content Ratios Thereof>

The identification of attribution of various monomer units in the amorphous resin and the crystalline polyester resin and the measurement of the content ratios thereof are performed under the following conditions by 1H-NMR.
Measuring apparatus: FT NMR apparatus JNM-EX400 (manufactured by JEOL Ltd.)
Measurement frequency: 400 MHZ
Pulse condition: 5.0 μs
Frequency range: 10,500 Hz
Number of scans: 64 times
Measurement temperature: 30° C.
Sample: 50 mg of a measurement sample is loaded into a sample tube having an inner diameter of 5 mm, and deuterated chloroform (CDCl₃) is added as a solvent to the tube. The sample is dissolved in the solvent in a thermostat at 40° C. to prepare a solution.

From the resultant ¹H-NMR chart, the structures of various monomer units are identified, and the integrated values S₁, S₂, S₃, . . . Sₙ of peaks attributed to the respective monomer units are calculated.

The content ratio of each of the various monomer units is determined by using the integrated values S₁, S₂, S₃, *** Sₙ as described below. n₁, n₂, n₃, . . . nₙ each represent the number of hydrogen atoms in each of the monomer units.

$$Content ratio of each of various monomer units ( mol \% ) = \{ ( {S}_{n} / {n}_{n} ) / ( ( {S}_{1} / {n}_{1} ) + ( {S}_{2} / {n}_{2} ) + ( {S}_{3} / {n}_{3} ) … + ( {S}_{n} / {n}_{n} ) ) \} \times 100$$

The content ratio of each of the various monomer units (mol %) is calculated by changing the numerator term in the same operation. When such a polymerizable monomer that each of the various monomer units is free of any hydrogen atom is used, the measurement is performed by using ¹³C-NMR through use of ¹³C as a measurement atomic nucleus in a single-pulse mode, and the calculation is performed in the same manner as in ¹H-NMR.

### <Method of Calculating SP Values of Amorphous Resin A and Crystalline Polyester Resin C>

The SP value of each of the amorphous resin A and the crystalline polyester resin C is calculated in accordance with a calculation method proposed by Fedors.

Specifically, the evaporation energy (Δei), molar volume (Δvi), and molar ratio (j) in the resin of each monomer unit are determined. The SP value is calculated through use of the determined values from the following equation.

$$SP value {( cal / {cm}^{3} )}^{0.5} = {\{ ( \sum j \times \sum Δ ei ) / ( \sum j \times \sum Δ vi ) \}}^{0.5}$$

Regarding the evaporation energy (Δei) and molar volume (Δvi) of an atom or an atomic group in the monomer unit, values described in “Polym. Eng. Sci., 14 (2), 147-154 (1974)” are used.

### <Method of Measuring Content W_{P} of Phosphorus Element in Toner>

The content W_{P} (mass ppm) of the phosphorus elements in the toner is measured with a multi-element simultaneous ICP emission spectrometer Vista-PRO (manufactured by Hitachi High-Tech Science Corporation).
Sample: 50 mg
Solvent: 6 mL of nitric acid

The above-mentioned materials were weighed and subjected to decomposition treatment with a microwave sample pretreatment device ETHOS UP (manufactured by Milestone General K.K.).

Temperature: The temperature is increased from 20° C. to 230° C. and held at 230° C. for 30 minutes.

The decomposed solution is passed through filter paper (5C). After that, the decomposed solution is transferred to a 50-mL measuring flask and diluted to 50 mL with ultrapure water. The aqueous solution in the measuring flask is measured with the multi-element simultaneous ICP emission spectrometer Vista-PRO under the following conditions, thereby being capable of quantifying the content of the phosphorus elements in the toner. In the quantification of the content, a calibration curve is prepared through use of a standard sample of the elements to be quantified, and the content is calculated based on the calibration curve.
Condition: RF power 1.20 kW
Ar gas: Plasma flow 15.0 L/min
Auxiliary flow: 1.50 L/min
MFC: 1.50 L/min
Nebulizer flow: 0.90 L/min
Liquid feed pump speed: 15 rpm
Measurement repetition: 3 times
Measurement time: 1.0 s

### <Developer>

The toner may also be used as a one-component developer, but it is preferred that the toner be mixed with a magnetic carrier to be used as a two-component developer in order to improve dot reproducibility and to provide stable images for a long period of time. As the magnetic carrier, for example, those which are generally known including particles of metals, such as iron, cobalt, and nickel, and a magnetic substance, such as ferrite, may be used.

According to the present disclosure, an electrophotographic apparatus in which the occurrence of a streak-like image defect is suppressed even under the high-temperature and high-humidity usage environment when an a-Si photosensitive member and a toner containing a polyester resin having a polyethylene terephthalate segment are used in combination can be provided.

### EXAMPLES

The present disclosure is further described below in detail by way of Examples, but the present disclosure is not limited to these examples. The numbers of parts in the following formulations are all based on the mass unless otherwise stated.

### [Production Examples of Electrophotographic Photosensitive Members 1 to 16]

An aluminum alloy raw pipe (outer diameter: 84 mm, length: 370 mm) was prepared as a conductive substrate having a cylindrical shape.

The outer peripheral surface of the prepared conductive substrate was subjected to mirror processing and wet blast processing, followed by washing.

First, as the mirror processing of the surface of the conductive substrate, the conductive substrate was subjected to burnishing processing at a feed rate of from 0.08 mm/sec to 0.5 mm/sec while a diamond cutting tool was pressed thereagainst under a state in which the conductive substrate was held at both ends and rotated at a high speed of from 1,500 rpm to 8,000 rpm. That is, a finishing surface of the diamond cutting tool having a depth in a workpiece rotation direction was pressed against the surface of the conductive substrate to provide a smooth finishing surface.

After such mirror processing, the conductive substrate was degreased and washed.

Next, as the wet blast processing, an abrasive material having high hardness, such as alumina, and water were stirred, and the resultant was mixed and accelerated with compressed air to be projected onto the surface of the conductive substrate subjected to the mirror processing, to thereby roughen the surface. In this method, the conductive substrate is subjected to processing treatment while being rotated, and hence a processed surface excellent in uniformity can be formed within a short period of time.

Specifically, conductive substrates having different surface roughnesses were prepared by adjusting the following parameters as the conditions of the wet blast processing.

Abrasive material type and particle diameter: A (Alundum (brown fused alumina)) #320 to #4,000
Abrasive material concentration: from 10% to 18%
Projection air pressure: from 0.10 MPa to 0.35 MPa
Projection distance (distance between the center of a workpiece and a blast head): from 20 mm to 300 mm
Projection time: from 1 second to 60 seconds
Number of rotations of workpiece: from 120 rpm to 180 rpm

The surface roughness was adjusted by changing the abrasive material type and particle diameter, the concentration, the projection air pressure, the projection distance, and the projection time.

After the wet blasting, any residue remaining on the surface was removed by washing. Thus, a conductive substrate was prepared.

The respective layers were formed so as to have the layer configuration of FIG. 2 on the surface of the conductive substrate prepared as described above under film formation conditions shown in Tables 1, 2-1 and 2-2 with the deposition apparatus illustrated in FIG. 3 to produce an a-Si photosensitive member.

Film formation was performed by changing the flow rate of each of raw material gases and the high frequency power as shown in Table 1 so that the number of carbon atoms in the first region of the surface protective layer was continuously changed.

In addition, the flow rate of each of the raw material gases, the reaction pressure, the high frequency power, and the substrate temperature at the time of formation of the third region of the surface protective layer were set to the conditions shown in Tables 2-1 and 2-2.

TABLE 1

| | | | Charge | | | | |
|---|---|---|---|---|---|---|---|
| | | Pressure- | injection | Photo- | Surface protective layer | | |
| | | resistant | blocking | conductive | First | Second | Third |
| | | layer | layer | layer | region | region | region |
| Kind | SiH₄ | 290 | 350 | 450 | 450→10 | 10 | (Tables 2-1 |
| of gas | [ml/min (normal)] | | | | | | and 2-2) |
| | H₂ | 750 | 750 | 2,200 | 2,200→ | 1,700 | (Tables 2-1 |
| | [ml/min (normal)] | | | | 1,700 | | and 2-2) |
| | B₂H₆ [ppm] | | 1,500 | 1 | | | |
| | (with respect to SiH₄) | | | | | | |
| | NO | 20 | 10 | | | | |
| | [ml/min (normal)] | | | | | | |
| | NH₃ | 60 | | | | | |
| | [ml/min (normal)] | | | | | | |
| | CH₄ | | | | 0→190 | 190 | (Tables 2-1 |
| | [ml/min (normal)] | | | | | | and 2-2) |

| | | | | | | |
|---|---|---|---|---|---|---|
| Reaction pressure [Pa] | 40 | 40 | 80 | 80 | 80 | (Tables 2-1 |
| | | | | | | and 2-2) |
| High frequency power [W] | 400 | 400 | 800 | 800→ | 400 | (Tables 2-1 |
| | | | | 400 | | and 2-2) |
| Substrate temperature [° C.] | 260 | 260 | 260 | 260 | 260 | (Tables 2-1 |
| | | | | | | and 2-2) |
| Thickness [μm] | 5.5 | 3.5 | 20 | 0.4 | 0.4 | 0.2 |

TABLE 2-1

| | | Electrophotographic | Electrophotographic | Electrophotographic | Electrophotographic | Electrophotographic |
|---|---|---|---|---|---|---|
| | | photosensitive | photosensitive | photosensitive | photosensitive | photosensitive |
| | | members 1 to 5 | member 6 | member 7 | member 8 | member 9 |
| Kind | SiH₄ | 1 | 0.1 | 0.05 | 1.5 | 4 |
| of | [ml/min | | | | | |
| gas | (normal)] | | | | | |
| | H₂ | 110 | 110 | 110 | 110 | 110 |
| | [ml/min | | | | | |
| | (normal)] | | | | | |
| | CH₄ | 290 | 290 | 290 | 200 | 200 |
| | [ml/min | | | | | |
| | (normal)] | | | | | |

| | | | | | |
|---|---|---|---|---|---|
| Reaction pressure [Pa] | 80 | 80 | 80 | 80 | 80 |
| High frequency power [W] | 400 | 400 | 400 | 400 | 400 |
| Substrate temperature [° C.] | 260 | 260 | 260 | 260 | 260 |

TABLE 2-2

| | | Electro- | Electro- | Electro- | Electro- |
|---|---|---|---|---|---|
| | | photo- | photo- | photo- | photo- |
| | | graphic | graphic | graphic | graphic |
| | | photosen- | photosen- | photosen- | photosen- |
| | | sitive | sitive | sitive | sitive |
| | | members | member | member | member |
| | | 10 to 13 | 14 | 15 | 16 |
| Kind | SiH₄ | 6 | 8.5 | 10 | 20 |
| of | [ml/min | | | | |
| gas | (normal)] | | | | |
| | H₂ | 110 | 110 | 110 | 110 |
| | [ml/min | | | | |
| | (normal)] | | | | |
| | CH₄ | 200 | 200 | 200 | 200 |
| | [ml/min | | | | |
| | (normal)] | | | | |

| | | | | |
|---|---|---|---|---|
| Reaction | 80 | 80 | 80 | 80 |
| pressure | | | | |
| [Pa] | | | | |
| High | 400 | 450 | 500 | 500 |
| frequency | | | | |
| power [W] | | | | |
| Substrate | 260 | 260 | 260 | 260 |
| temperature | | | | |
| [° C.] | | | | |

The surface profile of each of the electrophotographic photosensitive members 1 to 16 obtained as described above was measured.

In the measurement, the surface profile was evaluated with a laser microscope VK-X100 manufactured by Keyence Corporation through use of three-dimensional roughness parameters in conformity with ISO 25178. As the measurement conditions, the measurement was performed through use of a lens having a magnification of 100 times. An object to be measured had a cylindrical shape, and hence curvature correction was performed in a two-dimensional direction and an arithmetic average roughness Sa was calculated.

The measurement was performed at a total of 28 positions on the electrophotographic photosensitive member: 7 positions in an axis direction (center, +50 mm, +100 mm, +150 mm) and 4 positions in a circumferential direction (every) 90°, and an average thereof was defined as the arithmetic average roughness Sa of the electrophotographic photosensitive member.

The results are shown in Table 3.

In addition, the Si atom density in the region in the vicinity of the surface (surface region A) of the electrophotographic photosensitive member from the surface to a depth of 100 nm was determined by the following method.

The thickness information of the surface layer was obtained by spectroscopic ellipsometry in accordance with the method described in Japanese Patent Application Laid-Open No. 2010-49241. Next, the number of Si atoms was determined by the Rutherford backscattering method in accordance with the method described in Japanese Patent Application Laid-Open No. 2010-49241, and the determined number of Si atoms was combined with the thickness information of the surface layer described above to determine the Si atom density of the surface region A. The results thus obtained are shown in Table 3.

TABLE 3

| | Arithmetic average | |
|---|---|---|
| | roughness Sa of | Si atom density of |
| | surface | region A |
| | [nm] | [×10²² atoms/cm³] |
| Electrophotographic | 90 | 0.20 |
| photosensitive member 1 | | |
| Electrophotographic | 80 | 0.20 |
| photosensitive member 2 | | |
| Electrophotographic | 120 | 0.20 |
| photosensitive member 3 | | |
| Electrophotographic | 152 | 0.20 |
| photosensitive member 4 | | |
| Electrophotographic | 29 | 0.20 |
| photosensitive member 5 | | |
| Electrophotographic | 91 | 0.05 |
| photosensitive member 6 | | |
| Electrophotographic | 89 | 0.02 |
| photosensitive member 7 | | |
| Electrophotographic | 90 | 0.41 |
| photosensitive member 8 | | |
| Electrophotographic | 91 | 0.82 |
| photosensitive member 9 | | |
| Electrophotographic | 80 | 1.00 |
| photosensitive member 10 | | |
| Electrophotographic | 120 | 1.00 |
| photosensitive member 11 | | |
| Electrophotographic | 29 | 1.00 |
| photosensitive member 12 | | |
| Electrophotographic | 152 | 1.00 |
| photosensitive member 13 | | |
| Electrophotographic | 90 | 1.25 |
| photosensitive member 14 | | |
| Electrophotographic | 90 | 1.51 |
| photosensitive member 15 | | |
| Electrophotographic | 90 | 2.81 |
| photosensitive member 16 | | |

### [Production Example 1 of Toner]

### <Measurement Method for Softening Point of Resin>

The softening point of a resin is measured with a constant-pressure extrusion system capillary rheometer (product name: flow characteristic-evaluating Flow Tester CFT-500D, manufactured by Shimadzu Corporation) in accordance with the manual attached to the apparatus. In this apparatus, a measurement sample filled in a cylinder is increased in temperature to be melted while a predetermined load is applied to the measurement sample with a piston from above, and the melted measurement sample is extruded from a die in a bottom part of the cylinder. At this time, a flow curve representing a relationship between a piston descent amount and the temperature can be obtained.

A “melting temperature in a 1/2 method” described in the manual attached to the flow characteristic-evaluating Flow Tester CFT-500D is adopted as the softening point. The melting temperature in the 1/2 method is calculated as described below. First, 1/2 of a difference between a descent amount (Smax) of the piston at a time when the outflow is finished and a descent amount (Smin) of the piston at a time when the outflow is started is determined (The 1/2 of the difference is represented by X. X=(Smax−Smin)/2). Then, the temperature when the descent amount of the piston reaches the sum of X and Smin in the flow curve is the melting temperature in the 1/2 method.

The measurement sample to be used is obtained by subjecting about 1.0 g of the resin to compression molding at about 10 MPa for about 60 seconds through use of a tablet compressing machine (e.g., NT-100H, manufactured by NPa SYSTEM Co., Ltd.) under an environment at 25° C. to form the sample into a columnar shape having a diameter of about 8 mm.

The measurement conditions of the CFT-500D are as described below.
Test mode: heating method
Starting temperature: 50° C.
Reached temperature: 200° C.
Measurement interval: 1.0° C.
Rate of temperature increase: 4.0° C./min
Piston sectional area: 1.000 cm²
Test load (piston load): 10.0 kgf/cm² (0.9807 MPa)
Preheating time: 300 seconds
Diameter of hole of die: 1.0 mm
Length of die: 1.0 mm

### <Production Example of Resin 1>

The following materials were loaded into a reaction vessel with a reflux condenser, a stirring machine, a temperature gauge, and a nitrogen-introducing tube under a nitrogen atmosphere.
Propylene oxide adduct of bisphenol A (average number of moles added: 2.2 mol) 100 parts by mass
Recovered polyethylene terephthalate resin (content of diethylene glycol=1.3 mass %) 21 parts by mass
Dibutyltin oxide 0.08 part by mass

A reaction was performed for 7 hours by heating the inside of the reaction vessel to 230° C. under stirring at 200 rpm. Subsequently, the mixture was cooled to 180° C., and 30 parts by mass of fumaric acid and 0.08 part by mass of hydroquinone were loaded into the reaction vessel, followed by heating to 210° C. over 4 hours. After that, the inside of the reaction vessel was reduced in pressure to 8 kPa, and the resultant was subjected to a reaction until the softening point of 103° C. was achieved. Thus, a resin 1 was obtained.

### <Production Example of Resin 2>

The following materials were loaded into a reaction vessel with a reflux condenser, a stirring machine, a temperature gauge, and a nitrogen-introducing tube under a nitrogen atmosphere.
Propylene oxide adduct of bisphenol A (average number of moles added: 2.2 mol) 100 parts by mass
Ethylene oxide adduct of bisphenol A (average number of moles added: 2.2 mol) 40 parts by mass
Dodecenylsuccinic anhydride 13 parts by mass
Terephthalic acid 37 parts by mass
Trimellitic anhydride 12 parts by mass
Dibutyltin oxide 0.5 part by mass

A reaction was performed for 4 hours by heating the inside of the reaction vessel to 235° C. under stirring at 200 rpm. After that, the inside of the reaction vessel was reduced in pressure to 8 kPa, and the resultant was subjected to a reaction until the softening point of 146° C. was achieved. Thus, a resin 2 was obtained.

### <Production Example of Toner Particles 1>

Resin 1 70 parts by mass
Resin 2 30 parts by mass
Carbon black R330R (manufactured by Cabot Corporation) 7 parts by mass
Charge control agent BONTRON P-51 (manufactured by Orient Chemical Industries Co., Ltd.) 0.5 part by mass
Release agent Carnauba Wax No. 1 (manufactured by S. Kato & Co.) 4 parts by mass

The above-mentioned materials were mixed with a Henschel mixer (model FM-75, manufactured by Nippon Coke & Engineering Co., Ltd.) at a number of rotations of 20 s⁻¹ for a time of rotation of 5 min. After that, the mixture was kneaded with a twin-screw kneading machine set to a temperature of 120° C. and a number of rotations of a screw of 200 rpm (model PCM-30, manufactured by Ikegai Corp.) at a discharge temperature of 135° C. The kneaded product thus obtained was cooled at a cooling speed of 15° C./min and coarsely pulverized with a hammer mill to 1 mm or less to provide a coarsely pulverized product. The coarsely pulverized product thus obtained was finely pulverized with a mechanical pulverizer (T-250, manufactured by FREUND-Turbo Corporation). Further, the finely pulverized product was classified with Faculty F-300 (manufactured by Hosokawa Micron Corporation) to provide toner particles 1. The operating conditions were as follows: the number of rotations of a classification rotor was set to 130 s⁻¹ and the number of rotations of a dispersion rotor was set to 120 s⁻¹.

### <Production Example of Toner 1>

The following materials were mixed with a Henschel mixer (model FM-10C, manufactured by Nippon Coke & Engineering Co., Ltd.) at a number of rotations of 30 s⁻¹ for a time of rotation of 10 min to provide a toner 1.
Toner particles 1 100 parts by mass
Silica fine particles subjected to surface treatment with hexamethyldisilazane having an average particle diameter of 130 nm 2.1 parts by mass
Silica fine particles subjected to surface treatment with hexamethyldisilazane having an average particle diameter of 20 nm 0.7 parts by mass

### [Production Example of Magnetic Carrier]

### <Production Example of Magnetic Carrier Core Particles>

Fe₂O₃ 62.7 parts by mass.
MnCO₃ 29.5 parts by mass
Mg(OH)₂ 6.8 parts by mass
SrCO₃ 1.0 part by mass

A ferrite raw material was weighed so that the above-mentioned materials had the above-mentioned composition ratio.

After that, the materials were pulverized and mixed with a dry vibration mill using stainless-steel beads for 5 hours. The pulverized product thus obtained was formed into about 1 mm square pellets with a roller compactor.

The pellets were sieved with a vibration sieve having an aperture of 3 mm so that coarse powder was removed, and were then sieved with a vibration sieve having an aperture of 0.5 mm so that fine powder was removed. After that, the resultant was calcined with a burner-type calcination furnace at a temperature of 1,000° C. for 4 hours under a nitrogen atmosphere (oxygen concentration: 0.01 vol %) to produce calcined ferrite.

The calcined ferrite was pulverized with a crusher to about 0.3 mm. After that, 30 parts by mass of water was added to 100 parts by mass of the calcined ferrite, and the resultant was pulverized with a wet ball mill for 1 hour through use of zirconia beads. Further, the slurry thus obtained was pulverized with a wet ball mill for 4 hours to provide a ferrite slurry (finely pulverized product of calcined ferrite).

1.0 Part by mass of ammonium polycarboxylate serving as a dispersant and 2.0 parts by mass of polyvinyl alcohol serving as a binder with respect to 100 parts by mass of the calcined ferrite were added to the ferrite slurry, and the mixture was granulated into spherical particles with a spray dryer (manufacturer: Ohkawara Kakohki Co., Ltd.). After the particle size of the particles thus obtained was adjusted, the resultant was heated at 650° C. for 2 hours with a rotary kiln so that organic components of the dispersant and the binder were removed.

In order to control the calcination atmosphere, the temperature was increased from room temperature to 1,300° C. in 2 hours in an electric furnace under a nitrogen atmosphere (oxygen concentration: 1.00 vol %), followed by calcination at a temperature of 1,150° C. for 4 hours. After that, the temperature was reduced to 60° C. over 4 hours, the atmosphere was returned from the nitrogen atmosphere to an atmospheric atmosphere, and the resultant was removed at a temperature of 40° C. or less.

After the aggregated particles were shredded, a low-magnetic force product was cut by magnetic separation, and the remainder was sieved with a sieve having an aperture of 250 μm so that coarse particles were removed. Thus, magnetic carrier core particles having a volume-based 50% particle diameter (D50) of 37.0 μm were obtained.

### <Production Example of Magnetic Carrier 1>

As a first coating step, a thermosetting silicone resin solution (methyl silicone resin) was applied to the magnetic carrier core particles. The amount of the resin for coating was set to 0.20 part by mass with respect to 100 parts by mass of the magnetic carrier core particles. In the application, a coating device, in which a rotary bottom plate disk and a stirring blade were installed in a fluidized bed so that coating was performed while a swirling flow was formed, was used. The above-mentioned resin solution was sprayed from a direction perpendicular to the movement direction of the fluidized bed in the device.

Next, the following materials were prepared.
Fluororesin solution (copolymer of tetrafluoroethylene and hexafluoropropylene (FEP)) (1.91 parts by mass with respect to 100 parts by mass of the magnetic carrier core particles in terms of solid content)
Thermosetting melamine resin solution (0.09 part by mass with respect to 100 parts by mass of the magnetic carrier core particles in terms of solid content)

Those materials were sufficiently stirred to be mixed to produce a carrier coating solution. The carrier coating solution was applied to the magnetic carrier core particles as a second coating step. In the application, a coating device, in which a rotary bottom plate disk and a stirring blade were installed in a fluidized bed so that coating was performed while a swirling flow was formed, was used. After that, the carrier thus obtained was dried in the fluidized bed at a temperature of 280° C. for 1 hour so that a solvent was removed. Thus, a magnetic carrier 1 was obtained.

### [Production Example of Developer 1]

The following materials were mixed with a V-type mixer (V-20, manufactured by Seishin Enterprise Co., Ltd.) to provide a developer 1.
Toner 1 8 parts by mass
Magnetic carrier 1 92 parts by mass

### Example 1

A reconstructed machine of a copying machine imagePRESS C800 manufactured by Canon Inc. was used as an electrophotographic apparatus.

More specifically, the copying machine was reconstructed so that its charging system became positive charging. In addition, the configuration of a cleaning unit was reconstructed to a configuration including a rubbing roller that rubs an electrophotographic photosensitive member with an elastic sponge and a cleaning blade so as to provide an electrophotographic apparatus having the configuration illustrated in FIG. 1.

In addition, the cleaning blade was adjusted so as to be brought into abutment against the electrophotographic photosensitive member at an abutment pressure of 40 g/cm, and the rubbing roller and cleaning blade of the cleaning unit were replaced by new components in order to reproduce the state in the initial stage of use of the electrophotographic apparatus.

The electrophotographic photosensitive member 1 was set in a black station of the prepared electrophotographic apparatus, and the developer 1 was set in a developing device as a developer.

### (Evaluation of Image)

The evaluation of an image was performed under an environment at 32° C./85% RH.

As the image for evaluation, a half-tone image with a pixel density of 5% was output on 30 sheets of A4 paper by continuous printing, and then a half-tone image with a pixel density of 25% was output on one sheet of A4 paper.

Further, a half-tone image with a pixel density of 5% was output on 200 sheets of A4 paper by continuous printing, and then a half-tone image with a pixel density of 25% was output on one sheet of A4 paper.

Evaluation was performed regarding a streak-like image defect in accordance with the following evaluation criteria. The results are shown in Table 4.

### (Evaluation Criteria)

A: The occurrence of image defects is not recognized in any of the images.
B: Some images suspected to have image defects are obtained, but the image defects remain at a level in which the image defects cannot be determined to be clear.
C: Extremely minor image defects at a level in which there are no problems in practical use occur slightly in some images.
D: Clear image defects occur in the images.

### Examples 2 to 13 and Comparative Examples 1 to 3

As Examples 2 to 13 and Comparative Examples 1 to 3, the combinations of electrophotographic photosensitive members and developers shown in Table 4 were evaluated in the same manner as in Example 1. The evaluation results are shown in Table 4.

TABLE 4

| | | | Image |
|---|---|---|---|
| | Electrophotographic | | evaluation |
| | photosensitive member | Developer | results |
| Example 1 | Electrophotographic | Developer 1 | A |
| | photosensitive member 1 | | |
| Example 2 | Electrophotographic | Developer 1 | A |
| | photosensitive member 2 | | |
| Example 3 | Electrophotographic | Developer 1 | A |
| | photosensitive member 3 | | |
| Example 4 | Electrophotographic | Developer 1 | B |
| | photosensitive member 4 | | |
| Example 5 | Electrophotographic | Developer 1 | B |
| | photosensitive member 5 | | |
| Example 6 | Electrophotographic | Developer 1 | A |
| | photosensitive member 6 | | |
| Example 7 | Electrophotographic | Developer 1 | A |
| | photosensitive member 7 | | |
| Example 8 | Electrophotographic | Developer 1 | B |
| | photosensitive member 8 | | |
| Example 9 | Electrophotographic | Developer 1 | B |
| | photosensitive member 9 | | |
| Example 10 | Electrophotographic | Developer 1 | B |
| | photosensitive member 10 | | |
| Example 11 | Electrophotographic | Developer 1 | B |
| | photosensitive member 11 | | |
| Example 12 | Electrophotographic | Developer 1 | C |
| | photosensitive member 12 | | |
| Example 13 | Electrophotographic | Developer 1 | C |
| | photosensitive member 13 | | |
| Comparative | Electrophotographic | Developer 1 | D |
| Example 1 | photosensitive member 14 | | |
| Comparative | Electrophotographic | Developer 1 | D |
| Example 2 | photosensitive member 15 | | |
| Comparative | Electrophotographic | Developer 1 | D |
| Example 3 | photosensitive member 16 | | |

### [Production Example 2 of Toner]

### <Production of Amorphous Resin A1>

Polyethylene terephthalate (molecular weight: 2,000, intrinsic viscosity: 0.1): 20.9 parts by mass (42.0 mol %)
Propylene oxide adduct of bisphenol A (average number of moles added: 2.0 mol): 47.4 parts by mass (29.0 mol %)
Terephthalic acid: 15.8 parts by mass (18.3 mol %)
Dodecenylsuccinic acid: 15.8 parts by mass (10.6 mol %)
Titanium tetrabutoxide (esterification catalyst): 0.5 part by mass
Gallic acid (promoter): 0.1 part by mass

The above-mentioned materials were weighed in a reaction vessel with a condenser, a stirring machine, a nitrogen-introducing tube, and a thermocouple. The molar ratio of polyethylene terephthalate is a value as the number of units obtained by adding up the number of units derived from ethylene glycol and the number of units derived from terephthalic acid.

Next, the flask was purged with a nitrogen gas, and then a temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After it was confirmed that the weight-average molecular weight reached 6,700, the temperature was reduced to stop the reaction. Thus, an amorphous resin A1 having a polyethylene terephthalate segment in a molecule thereof was obtained. The physical properties of the amorphous resin A1 obtained by the above-mentioned measurement method are shown in Table 4.

### <Production of Amorphous Resins A2 to A11>

A reaction was performed in the same manner as in the production of the amorphous resin A1 except that the kinds and numbers of parts of polyethylene terephthalate and polymerizable monomers were changed as shown in Tables 5-1 to 5-3 in the production of the amorphous resin A1. Thus, amorphous resins A2 to A11 each having a polyethylene terephthalate segment in a molecule thereof were obtained. The physical properties of the amorphous resins A2 to A11 obtained by the above-mentioned measurement method are shown in Tables 5-1 to 5-3.

TABLE 5-1

| | | Amorphous resin | | Amorphous resin | | Amorphous resin | | Amorphous resin | |
|---|---|---|---|---|---|---|---|---|---|
| | | A1 | | A2 | | A3 | | A4 | |
| | | Number | | Number | | Number | | Number | |
| | | of parts | mol % | of parts | mol % | of parts | mol % | of parts | mol % |
| Polyethylene terephthalate | | 20.9 | 42.0 | 11.0 | 24.9 | 27.0 | 49.9 | 22.7 | 43.1 |
| Alcohol | BPA-PO | 47.4 | 29.0 | 53.4 | 37.6 | 43.8 | 25.1 | 50.6 | 29.8 |
| component | BPA-EO | | | | | | | | |
| Carboxylic | Terephthalic | 15.8 | 18.3 | 17.8 | 23.7 | 14.6 | 15.8 | 16.9 | 18.8 |
| acid | acid | | | | | | | | |
| component | Dodecenylsuccinic | 15.8 | 10.6 | 17.8 | 13.8 | 14.6 | 9.2 | | |
| | acid | | | | | | | | |
| | Tetradecanedioic | | | | | | | 10.1 | 8.3 |
| | acid | | | | | | | | |
| | Suberic acid | | | | | | | | |
| | Octadecanedioic | | | | | | | | |
| | acid | | | | | | | | |
| | Adipic acid | | | | | | | | |
| | Eicosanedioic | | | | | | | | |
| | acid | | | | | | | | |
| | Trimellitic acid | | | | | | | | |
| Physical | SP value | 11.30 | | 11.10 | | 11.44 | | 11.30 | |
| properties | | | | | | | | | |

TABLE 5-2

| | | Amorphous resin | | Amorphous resin | | Amorphous resin | | Amorphous resin | |
|---|---|---|---|---|---|---|---|---|---|
| | | A5 | | A6 | | A7 | | A8 | |
| | | Number | | Number | | Number | | Number | |
| | | of parts | mol % | of parts | mol % | of parts | mol % | of parts | mol % |
| Polyethylene terephthalate | | 22.6 | 41.1 | 23.0 | 44.7 | 10.0 | 22.9 | 28.5 | 51.7 |
| Alcohol | BPA-PO | 55.0 | 29.5 | 52.2 | 30.9 | 54.0 | 38.6 | 42.9 | 24.2 |
| component | BPA-EO | | | | | | | | |
| Carboxylic | Terephthalic | 5.5 | 5.6 | 17.4 | 19.5 | 18.0 | 24.3 | 14.3 | 15.2 |
| acid | acid | | | | | | | | |
| component | Dodecenylsuccinic | | | | | 18.0 | 14.1 | 14.3 | 8.9 |
| | acid | | | | | | | | |
| | Tetradecanedioic | | | | | | | | |
| | acid | | | | | | | | |
| | Suberic acid | 16.0 | 23.8 | | | | | | |
| | Octadecanedioic | | | 7.4 | 4.9 | | | | |
| | acid | | | | | | | | |
| | Adipic acid | | | | | | | | |
| | Eicosanedioic | | | | | | | | |
| | acid | | | | | | | | |
| | Trimellitic acid | | | | | | | | |
| Physical | SP value | 11.30 | | 11.30 | | 11.08 | | 11.47 | |
| properties | | | | | | | | | |

TABLE 5-3

| | | Amorphous | | Amorphous | | Amorphous | |
|---|---|---|---|---|---|---|---|
| | | resin A9 | | resin A10 | | resin A11 | |
| | | Number | | Number | | Number | |
| | | of parts | mol % | of parts | mol % | of parts | mol % |
| Polyethylene terephthalate | | 22.6 | 41.1 | 23.0 | 45.1 | 28.7 | 55.7 |
| Alcohol | BPA-PO | 55.0 | 29.5 | 52.4 | 31.1 | 36.6 | 21.7 |
| component | BPA-EO | | | | | 14.6 | 9.5 |
| Carboxylic | Terephthalic | 5.5 | 5.6 | 17.5 | 19.6 | 2.2 | 2.5 |
| acid | acid | | | | | | |
| component | Dodecenylsuccinic | | | | | 9.3 | 6.1 |
| | acid | | | | | | |
| | Tetradecanedioic | | | | | | |
| | acid | | | | | | |
| | Suberic acid | | | | | | |
| | Octadecanedioic | | | | | | |
| | acid | | | | | | |
| | Adipic acid | 16.0 | 23.8 | | | | |
| | Eicosanedioic | | | 7.0 | 4.2 | | |
| | acid | | | | | | |
| | Trimellitic acid | | | | | 8.6 | 4.5 |
| Physical | SP value | 11.30 | | 11.30 | | 11.45 | |
| properties | | | | | | | |

The abbreviations in Tables 5-1 to 5-3 are as described below.
BPA-PO: propylene oxide adduct of bisphenol A (average number of moles added: 2.0 mol)
BPA-EO: ethylene oxide adduct of bisphenol A (average number of moles added: 2.0 mol)

### <Production of Amorphous Resin B1>

Polyethylene terephthalate (molecular weight: 2,000, intrinsic viscosity: 0.1): 4.1 parts by mass (9.8 mol %)
Propylene oxide adduct of bisphenol A (average of moles added: 2.0 mol): 57.8 parts by mass (42.8 mol %)
Terephthalic acid: 29.9 parts by mass (41.9 mol %)
Trimellitic acid: 7.0 parts by mass (4.5 mol %)
Stearic acid: 1.2 parts by mass (1.0 mol %)
Titanium tetrabutoxide (esterification catalyst): 0.5 part by mass
Gallic acid (promoter): 0.1 part by mass

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After it was confirmed that the weight-average molecular weight reached 1,000, the temperature was reduced to stop the reaction. Thus, an amorphous resin B1 was obtained. In the physical properties of the amorphous resin B1 obtained by the above-mentioned measurement method, the SP value was 11.54 (cal/cm³)^{0.5}.

### <Production of Crystalline Polyester Resin C1>

Ethylene glycol: 10.2 parts by mass (48.2 mol %)
Tetradecanedioic acid: 81.3 parts by mass (48.3 mol %)
Behenic acid: 8.5 parts by mass (3.5 mol %)
Titanium tetrabutoxide (esterification catalyst): 0.5 part by mass

The above-mentioned materials were weighed in a reaction vessel with a condenser, a stirring machine, a nitrogen-introducing tube, and a thermocouple. Next, the flask was purged with a nitrogen gas, and then the temperature therein was gradually increased while the materials were stirred. The materials were subjected to a reaction for 2 hours while being stirred at a temperature of 200° C.

Further, the materials were subjected to a reaction for 5 hours while the pressure in the reaction vessel was reduced to 8.3 kPa and the temperature therein was maintained at 200° C. After that, the temperature was reduced to stop the reaction. Thus, a crystalline polyester resin C1 was obtained. In the physical properties of the crystalline polyester resin C1 obtained by the above-mentioned measurement method, the SP value was 10.09 (cal/cm³)^{0.5}.

### <Production Example of Toner 2>

Amorphous resin A1: 66 parts by mass
Amorphous resin B1: 34 parts by mass
Crystalline polyester resin C1: 10 parts by mass
Fischer-Tropsch wax (peak temperature of maximum endothermic peak: 100° C.): 5 parts by mass
Carbon black: 5 parts by mass
Trisodium phosphate: 0.03 part by mass
Charge control agent BONTRON P-51 (manufactured by Orient Chemical Industries Co., Ltd.): 0.5 part by mass

The above-mentioned materials were mixed with a Henschel mixer (model FM-75, manufactured by Mitsui Mining Co., Ltd.) at a number of rotations of 1,500 rpm for a time of rotation of 5 min, and then the mixture was kneaded with a twin-screw kneading machine set to a temperature of 130° C. (model PCM-30, manufactured by Ikegai Corp.). The kneaded product thus obtained was cooled and coarsely pulverized with a hammer mill to 1 mm or less to provide a coarsely pulverized product. The coarsely pulverized product thus obtained was finely pulverized with a mechanical pulverizer (T-250, manufactured by Turbo Kogyo Co., Ltd.). Further, the finely pulverized product was classified with Faculty (F-300, manufactured by Hosokawa Micron Corporation) to provide toner particles 2. The operating conditions were as follows: the number of rotations of a classification rotor was set to 11,000 rpm and the number of rotations of a dispersion rotor was set to 7,200 rpm.
Toner particles 2: 95 parts by mass
Large-particle-diameter inorganic fine particles: fumed silica subjected to surface treatment with hexamethyldisilazane (number-based median diameter (D50): 120 nm) 4 parts by mass
Small-particle-diameter inorganic fine particles: titanium oxide fine particles subjected to surface treatment with isobutyltrimethoxysilane (number-based median diameter (D50): 10 nm) 1 part by mass

The above-mentioned materials were mixed with a Henschel mixer (model FM-75, manufactured by Mitsui Miike Chemical Engineering Machinery, Co., Ltd.) at a number of rotations of 1,900 rpm for a time of rotation of 10 min to provide a toner 2 showing positive chargeability. The physical properties of the toner 2 obtained by the above-mentioned measurement method are shown in Table 6.

### <Production Examples of Toners 3 to 19>

Toners 3 to 19 were each obtained by performing the same operation as that in the production example of the toner 2 except that the kinds and numbers of parts by mass of the amorphous resin A and additives were changed as shown in Table 6 in the production example of the toner 2. The physical properties of the toners 3 to 19 obtained by the above-mentioned measurement method are shown in Table 6.

TABLE 6

| | Toner | | | | | | | | | |
|---|---|---|---|---|---|---|---|---|---|---|
| | Internal additive formulation and physical properties | | | | | | | | | |
| | | | | | Crystalline | | | | | |
| | Amorphous | | Amorphous | | polyester | | | | | |
| | resin A | | resin B | | resin C | | Additive | | W_{P} | SP_{A}-SP_{C} |
| Kind | Kind | Part(s) | Kind | Part(s) | Kind | Part(s) | Kind | Part(s) | ppm | — |
| 2 | 1 | 66 | 1 | 34 | 1 | 10 | PNa | 0.160 | 250 | 1.21 |
| 3 | 2 | 66 | 1 | 34 | 1 | 10 | PNa | 0.160 | 250 | 1.01 |
| 4 | 3 | 66 | 1 | 34 | 1 | 10 | PNa | 0.160 | 250 | 1.35 |
| 5 | 1 | 66 | 1 | 34 | 1 | 10 | PNa | 0.320 | 500 | 1.21 |
| 6 | 1 | 66 | 1 | 34 | 1 | 10 | PNa | 0.013 | 20 | 1.21 |
| 7 | 1 | 66 | 1 | 34 | 1 | 10 | PNa | 0.004 | 5 | 1.21 |
| 8 | 1 | 66 | 1 | 34 | 1 | 10 | PF | 0.320 | 250 | 1.21 |
| 9 | 4 | 66 | 1 | 34 | 1 | 10 | PNa | 0.160 | 250 | 1.21 |
| 10 | 5 | 66 | 1 | 34 | 1 | 10 | PNa | 0.160 | 250 | 1.21 |
| 11 | 6 | 66 | 1 | 34 | 1 | 10 | PNa | 0.160 | 250 | 1.21 |
| 12 | 7 | 66 | 1 | 34 | 1 | 10 | PNa | 0.160 | 250 | 0.99 |
| 13 | 8 | 66 | 1 | 34 | 1 | 10 | PNa | 0.160 | 250 | 1.38 |
| 14 | 1 | 66 | 1 | 34 | 1 | 10 | PNa | 0.400 | 600 | 1.21 |
| 15 | 1 | 66 | 1 | 34 | 1 | 10 | — | — | 0 | 1.21 |
| 16 | 1 | 66 | 1 | 34 | 1 | 10 | PNa | 0.002 | 3 | 1.21 |
| 17 | 9 | 66 | 1 | 34 | 1 | 10 | PNa | 0.160 | 250 | 1.21 |
| 18 | 10 | 66 | 1 | 34 | 1 | 10 | PNa | 0.160 | 250 | 1.21 |
| 19 | 11 | 66 | 1 | 34 | 1 | 10 | PNa | 0.160 | 250 | 1.36 |

The abbreviations in Table 6 are as described below.
PNa: trisodium phosphate
PF: triphenyl phosphate

### <Production Examples of Developers 2 to 19>

Developers 2 to 19 were each obtained by performing the same operation as that in the production example of the developer 1 except that the kind of the toner was changed as shown in Table 7.

TABLE 7

| Developer | Toner | Carrier |
|---|---|---|
| Kind | Kind | Kind |
| 1 | 1 | 1 |
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 10 | 1 |
| 11 | 11 | 1 |
| 12 | 12 | 1 |
| 13 | 13 | 1 |
| 14 | 14 | 1 |
| 15 | 15 | 1 |
| 16 | 16 | 1 |
| 17 | 17 | 1 |
| 18 | 18 | 1 |
| 19 | 19 | 1 |

### Examples 14 to 31

The evaluation of each of the electrophotographic apparatus was performed in the same manner as in Example 1 except that the kinds of the electrophotographic photosensitive member and the developer were changed as shown in Table 8. In addition, the evaluation of scratch resistance and low-temperature fixability was also performed by the following method. The evaluation results are shown in Table 8.

### [Evaluation of Scratch Resistance/Low-Temperature Fixability]

A reconstructed machine of a printer for digital commercial printing “imagePRESS C800” manufactured by Canon Inc. was used as an image-forming apparatus. The electrophotographic photosensitive member 1 was set in a black station, and each developer was loaded into a developing device. As the reconstructed points of the apparatus, changes were made so that its fixation temperature and process speed, the DC voltage V_{DC} of a developer-carrying member, the charging voltage V_{D} of the electrophotographic photosensitive member, and laser power were able to be freely set. Image output evaluation was performed as follows: an FFh image (solid image) having a desired image print percentage was output and subjected to evaluations of scratch resistance and low-temperature fixability to be described later with the V_{DC}, the V_{D}, and the laser power being adjusted so as to achieve a desired toner laid-on level on the FFh image on paper. FFh is a value obtained by representing 256 gradations in hexadecimal notation; 00h represents the first gradation (white portion) of the 256 gradations, and FFh represents the 256th gradation (solid portion) of the 256 gradations.

### [Evaluation of Scratch Resistance]

Paper: UPM FINESSE GLOSS 300GSM
Toner laid-on level on paper: 0.05 mg/cm² (2Fh image)
(The toner laid-on level was adjusted based on the DC voltage V_{DC} of the developer-carrying member, the charging voltage V_{D} of the electrophotographic photosensitive member, and the laser power. The charging voltage V_{D} of the electrophotographic photosensitive member was set to positive charge.)
Evaluation image: An image measuring 3 cm×15 cm was arranged at the center of the above-mentioned A4 paper.
Fixing test environment: Normal-temperature and normal-humidity environment (temperature of 23° C./humidity of 50% RH (hereinafter referred to as “N/N”))
Fixing temperature: 180° C.
Process speed: 377 mm/sec

The above-mentioned evaluation image was output and evaluated for scratch resistance. Specifically, through use of a surface property tester HEIDON TYPE 14FW manufactured by SHINTO Scientific Co., Ltd., a 200 g weight was placed on the surface of the image, the surface was scratched with a needle having a diameter of 0.75 mm at a speed of 60 mm/min and a length of 30 mm, and the image was evaluated based on the scratches that appeared thereon. The area ratio of toner peeling was determined by binarizing the area in which toner peeling occurred with respect to the scratched area by image processing.

### (Evaluation Criteria)

A: 0.0%
B: 0.1% or more and less than 1.1%
C: 1.1% or more

### [Evaluation of Low-Temperature Fixability]

Paper: GFC-081 (81.0 g/m²) (sold from Canon Marketing Japan Inc.)
Toner laid-on level on paper: 0.50 mg/cm²
(The toner laid-on level was adjusted based on the DC voltage V_{DC} of the developer-carrying member, the charging voltage V_{D} of the electrophotographic photosensitive member, and the laser power. The charging voltage V_{D} of the electrophotographic photosensitive member was set to positive charge.)
Evaluation image: An image measuring 2 cm×5 cm was arranged at the center of the above-mentioned A4 paper.
Test environment: Low-temperature and low-humidity environment: temperature of 15° C./humidity of 10% RH (hereinafter referred to as “L/L”)
Fixing temperature: 150° C.
Process speed: 630 mm/sec

The evaluation image was output, and low-temperature fixability was evaluated. The value of an image density reduction ratio was used as an indicator for evaluating the low-temperature fixability.

Through use of an X-Rite color reflection densitometer (500 SERIES: manufactured by X-Rite, Inc.), the image density at the central portion of the image was measured first. Next, the fixed image was rubbed (back and forth 5 times) with lens-cleaning paper with the application of a load of 4.9 kPa (50 g/cm²) to the portion at which the image density was measured, and the image density was measured again.

Then, the reduction ratio of the image density after the rubbing as compared to that before the rubbing was calculated by using the following equation. The resultant image density reduction ratio was evaluated in accordance with the following evaluation criteria. A case of being evaluated as A to C was judged to be satisfactory.

Image density reduction ratio (%)=(image density before rubbing-image density after rubbing)/image density before rubbing×100

### (Evaluation Criteria)

A: An image density reduction ratio of less than 3%
B: An image density reduction ratio of 3% or more and less than 10%
C: An image density reduction ratio of 10% or more

TABLE 8

| | | | | | Evaluation | Evaluation | |
|---|---|---|---|---|---|---|---|
| | Electrophotographic | | | | result of | result of | Evaluation |
| | photosensitive | | | | streak-like | low- | result of |
| | member | Developer | Toner | Carrier | image | temperature | scratch |
| | Kind | Kind | Kind | Kind | defect | fixability | resistance |
| Example 14 | 1 | 2 | 2 | 1 | A | A | A |
| Example 15 | 1 | 3 | 3 | 1 | A | A | B |
| Example 16 | 1 | 4 | 4 | 1 | A | B | B |
| Example 17 | 1 | 5 | 5 | 1 | A | B | B |
| Example 18 | 1 | 6 | 6 | 1 | A | A | B |
| Example 19 | 1 | 7 | 7 | 1 | A | A | B |
| Example 20 | 1 | 8 | 8 | 1 | A | A | B |
| Example 21 | 1 | 9 | 9 | 1 | A | B | B |
| Example 22 | 1 | 10 | 10 | 1 | A | B | B |
| Example 23 | 1 | 11 | 11 | 1 | A | A | B |
| Example 24 | 1 | 12 | 12 | 1 | A | A | C |
| Example 25 | 1 | 13 | 13 | 1 | A | C | C |
| Example 26 | 1 | 14 | 14 | 1 | A | C | C |
| Example 27 | 1 | 15 | 15 | 1 | A | A | C |
| Example 28 | 1 | 16 | 16 | 1 | A | A | C |
| Example 29 | 1 | 17 | 17 | 1 | A | C | C |
| Example 30 | 1 | 18 | 18 | 1 | A | A | C |
| Example 31 | 1 | 19 | 19 | 1 | A | C | C |

In the toner to be used in the electrophotographic apparatus of the present disclosure, polyethylene terephthalate regenerated from a spent PET bottle or the like can be used as a toner material, and hence the technology described herein can contribute to the realization of a sustainable society such as a decarbonized/recycling-oriented society.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-002680, filed Jan. 11, 2024, and Japanese Patent Application No. 2024-176749, filed Oct. 8, 2024, which are hereby incorporated by reference herein in their entirety.

What is claimed is:

1. An electrophotographic apparatus comprising:
an electrophotographic photosensitive member;
a charging unit configured to charge a surface of the electrophotographic photosensitive member;
an image exposing unit configured to irradiate the charged surface of the electrophotographic photosensitive member with image exposure light to form an electrostatic latent image on the surface of the electrophotographic photosensitive member;
a developing unit, which includes a toner, and which is configured to develop the electrostatic latent image with the toner to form a toner image on the surface of the electrophotographic photosensitive member;
a transfer unit configured to transfer the toner image from the surface of the electrophotographic photosensitive member onto a transfer material; and
a cleaning unit configured to remove a residual toner remaining on the surface of the electrophotographic photosensitive member after the toner image is transferred onto the transfer material,
wherein the surface of the electrophotographic photosensitive member is formed of amorphous silicon carbide,
wherein a Si atom density in a region in the vicinity of the surface of the electrophotographic photosensitive member from the surface to a depth of 100 nm is 1.0×10²² atoms/cm³ or less, and
wherein the toner contains a toner particle that contains a polyester resin having a polyethylene terephthalate segment and an inorganic fine particle.

2. The electrophotographic apparatus according to claim 1, wherein the surface of the electrophotographic photosensitive member has an arithmetic average roughness Sa of 80 nm or more and 120 nm or less.

3. A process cartridge comprising:
an electrophotographic photosensitive member;
a developing unit, which includes a toner, and which is configured to develop an electrostatic latent image formed on a surface of the electrophotographic photosensitive member with the toner to form a toner image on the surface of the electrophotographic photosensitive member; and
a cleaning unit configured to remove a residual toner remaining on the surface of the electrophotographic photosensitive member after the toner image is transferred from the surface of the electrophotographic photosensitive member onto a transfer material,
the process cartridge integrally supporting the electrophotographic photosensitive member, the developing unit, and the cleaning unit, and being detachably attachable onto a main body of an electrophotographic apparatus,
wherein the surface of the electrophotographic photosensitive member is formed of amorphous silicon carbide,
wherein a Si atom density in a region in the vicinity of the surface of the electrophotographic photosensitive member from the surface to a depth of 100 nm is 1.0×10²² atoms/cm³ or less, and
wherein the toner contains a toner particle that contains a polyester resin having a polyethylene terephthalate segment and an inorganic fine particle.

4. The electrophotographic apparatus according to claim 1,
wherein the toner particle contains a binder resin, and the binder resin contains an amorphous resin A and a crystalline polyester resin C,
wherein the amorphous resin A is a polyester resin, and the amorphous resin A has, as structures for forming a polyester backbone,
(i) a polyethylene terephthalate segment, and
(ii) at least one structure selected from the group consisting of: a structure represented by the following formula (1); a structure represented by the following formula (2); a structure represented by the following formula (3); and a structure represented by the following formula (4): 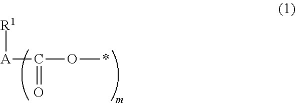
in the formula (1), R¹ represents an alkyl group having 6 to 16 carbon atoms or an alkenyl group having 6 to 16 carbon atoms,
A represents a hydrocarbon group,
“*” represents a bonding site in the polyester backbone, and
“m” represents an integer of 2 or more; 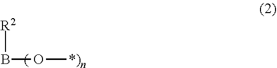
in the formula (2), R² represents an alkyl group having 6 to 16 carbon atoms or an alkenyl group having 6 to 16 carbon atoms,
B represents a hydrocarbon group,
“*” represents a bonding site in the polyester backbone, and
“n” represents an integer of 2 or more; 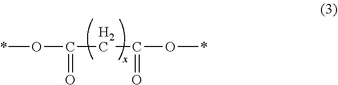
in the formula (3), “*” represents a bonding site in the polyester backbone, and
“x” represents an integer of from 6 to 16; 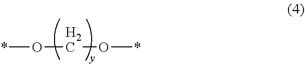
in the formula (4), “*” represents a bonding site in the polyester backbone, and
“y” represents an integer of from 6 to 16,
wherein, when an SP value of the amorphous resin A is represented by SP_{A} (cal/cm³)^{0.5}, and an SP value of the crystalline polyester resin C is represented by SP_{C} (cal/cm³)^{0.5}, the SP_{A} and the SP_{C} satisfy the following formula (C):
$$1. \leq {SP}_{A} - {SP}_{C} \leq 1.35 , \qquad ( C )$$
wherein the toner contains a phosphorus element derived from a phosphorus compound, and
wherein, when a content of the phosphorus element in the toner based on a mass of the toner is represented by W_{P} (ppm), the W_{P} satisfies the following formula (D):
$$5 \leq {W}_{P} \leq 500. \qquad ( D )$$

5. The electrophotographic apparatus according to claim 4, wherein the W_{P} satisfies the following formula (E):
$$20 \leq {W}_{P} \leq 500. \qquad ( E )$$

6. The process cartridge according to claim 3,
wherein the toner particle contains a binder resin, and the binder resin contains an amorphous resin A and a crystalline polyester resin C,
wherein the amorphous resin A is a polyester resin, and the amorphous resin A has, as structures for forming a polyester backbone,
(i) a polyethylene terephthalate segment, and
(ii) at least one structure selected from the group consisting of: a structure represented by the following formula (1); a structure represented by the following formula (2); a structure represented by the following formula (3); and a structure represented by the following formula (4): 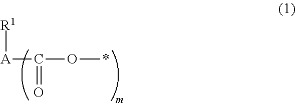
in the formula (1), R¹ represents an alkyl group having 6 to 16 carbon atoms or an alkenyl group having 6 to 16 carbon atoms,
A represents a hydrocarbon group,
“*” represents a bonding site in the polyester backbone, and
“m” represents an integer of 2 or more; 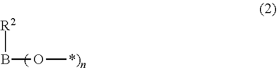
in the formula (2), R² represents an alkyl group having 6 to 16 carbon atoms or an alkenyl group having 6 to 16 carbon atoms,
B represents a hydrocarbon group,
“*” represents a bonding site in the polyester backbone, and
“n” represents an integer of 2 or more; 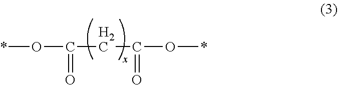
in the formula (3), “*” represents a bonding site in the polyester backbone, and
“x” represents an integer of from 6 to 16; 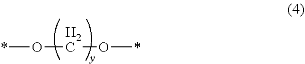
in the formula (4), “*” represents a bonding site in the polyester backbone, and
“y” represents an integer of from 6 to 16,
wherein, when an SP value of the amorphous resin A is represented by SP_{A} (cal/cm³)^{0.5}, and an SP value of the crystalline polyester resin C is represented by SP_{C} (cal/cm³)^{0.5}, the SP_{A} and the SP_{C} satisfy the following formula (C):
$$1. \leq {SP}_{A} - {SP}_{C} \leq 1.35 , \qquad ( C )$$
wherein the toner contains a phosphorus element derived from a phosphorus compound, and
wherein, when a content of the phosphorus element in the toner based on a mass of the toner is represented by W_{P} (ppm), the W_{P} satisfies the following formula (D):
$$5 \leq {W}_{P} \leq 500. \qquad ( D )$$

7. The process cartridge according to claim 6, wherein the W_{P} satisfies the following formula (E):
$$20 \leq {W}_{P} \leq 500. \qquad ( E )$$
